(19) United States
(12) Patent Application Publication
(10) Pub. No.: US 2010/0194794 A1
(43) Pub. Date: Aug. 5, 2010

(54) DISPLAY DEVICE HAVING DISPLAY ELEMENT OF DOT MATRIX TYPE AND A DRIVE METHOD OF THE SAME

(75) Inventors: Masaki Nose, Kawasaki (JP); Tomohisa Shingai, Kawasaki (JP); Hisashi Yamaguchi, Atsugi (JP); Yoshikazu Kuyama, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: FUJITSU LIMITED, Kawasaki-shi (JP); FUJITSU FRONTECH LIMITED, Tokyo (JP)

(21) Appl. No.: 12/756,634

(22) Filed: Apr. 8, 2010

Related U.S. Application Data
(63) Continuation of application No. PCT/JP2007/070099, filed on Oct. 15, 2007.

(51) Int. Cl. G09G 3/36; G09G 5/10

(52) U.S. Cl. 345/691; 345/89

(57) ABSTRACT

A display device includes a matrix-type display element, a drive circuit, a control circuit, and a temperature sensor, the control circuit controls the drive circuit so that an initialization pulse to initialize a pixel to be rewritten is applied to bring about an initial gradation state and then a gradation pulse is applied to the initialized pixel to bring about a gradation state, the cumulative time during which the gradation pulse is applied is related to the value of the gradation state, the control circuit fixes the pulse voltage of the initialization pulse and varies the pulse width of the initialization pulse in accordance with the temperature detected by the temperature sensor, and varies the pulse width of the gradation pulse when the temperature is low and varies the pulse voltage of the gradation pulse when the temperature detected is high.

### CROSS-REFERENCE TO RELATED APPLICATIONS

This application is a continuation application and is based upon PCT/JP2007/070099, filed on Oct. 15, 2007, the entire contents of which are incorporated herein by reference.

### FIELD

The embodiments discussed herein are related to a display device having a dot matrix-type display element and a drive method thereof.

### BACKGROUND

In recent years, the development of electronic paper has been promoted in companies, universities, etc. Applied fields expected to utilize electronic paper have been proposed, including a variety of fields, such as electronic books, a sub-display of mobile terminal equipment, and a display part of an IC card. One promising methods of electronic paper is that which uses a cholesteric liquid crystal. The cholesteric liquid crystal has excellent characteristics, such as the ability to semipermanently hold a display (memory properties), vivid color display, high contrast, and high resolution.

The cholesteric liquid crystal is also referred to as chiral nematic liquid crystal, which forms a cholesteric phase in which molecules of the nematic liquid crystal are in the form of a helix by adding a comparatively large amount (a few tens of percent) of additives (chiral material) having chiral property to the nematic liquid crystal.

FIGS. 1A and 1B are diagrams explaining the states of the cholesteric liquid crystal. As illustrated in FIG. 1A and FIG. 1B, a display element 10 that utilizes cholesteric liquid crystal has an upper side substrate 11, a cholesteric liquid crystal layer 12, and a lower side substrate 13. The cholesteric liquid crystal has a planar state in which incident light is reflected as illustrated in FIG. 1A and a focal conic state in which incident light is transmitted as illustrated in FIG. 1B, and theses states are maintained even if there is no electric field.

In the planar state, light having a wavelength in accordance with the helical pitch of liquid crystal molecules is reflected. A wavelength λ at which reflection is maximum is expressed by the following expression where n is an average refractive index and p is a helical pitch

λ=n·p.

On the other hand, a reflection band Δλ differs considerably depending on a refractive index anisotropy Δn of liquid crystal.

In the planar state, a “bright” state, i.e., white can be displayed because incident light is reflected. On the other hand, in the focal conic state, a “dark” state, i.e., black can be displayed because light having passed through the liquid crystal layer is absorbed by a light absorbing layer provided under the lower side substrate 13.

Next, a method of driving a display element that utilizes cholesteric liquid crystal is explained.

FIG. 2 illustrates an example of a voltage-reflection characteristic of general cholesteric liquid crystal. The horizontal axis represents a voltage value (V) of a pulse voltage to be applied with a predetermined pulse width between electrodes that sandwich cholesteric liquid crystal and the vertical axis represents a reflectivity (%) of cholesteric liquid crystal. A curve P of a solid line illustrated in FIG. 2 represents the voltage-reflectivity characteristic of the cholesteric liquid crystal when the initial state is the planar state and a curve FC of a broken line represents the voltage-reflectivity characteristic of the cholesteric liquid crystal when the initial state is the focal conic state.

In FIG. 2, if a predetermined high voltage VP100 (for example, ±36 V) is applied between the electrodes to generate a relatively strong electric field in the cholesteric liquid crystal, the helical structure of the liquid crystal molecules is undone completely and a homeotropic state is brought about, where all of the molecules align in the direction of the electric field. Next, when the liquid crystal molecules are in the homeotropic state, if the applied voltage is reduced rapidly from VP100 to a predetermined low voltage (for example, VF0=±4 V) to reduce the electric field in the liquid crystal almost to zero, the helical axis of the liquid crystal becomes perpendicular to the electrode and the planar state is brought about, where light in accordance with the helical pitch is reflected selectively.

On the other hand, if a predetermined low voltage VF100b (for example, ±24 V) is applied between electrodes to generate a relatively weak electric field in the cholesteric liquid crystal, a state is brought about where the helical structure of the liquid crystal molecules is not completely undone. In this state, if the applied voltage is reduced rapidly from VF100b to the low voltage VF0 to rapidly reduce the electric field in the liquid crystal almost to zero, or to gradually remove the electric field by applying a strong electric field, the helical axis of the liquid crystal molecule becomes parallel with the electrode and the focal conic state where incident light is transmitted is brought about.

Further, if the electric field is removed rapidly by applying an electric field of intermediate strength, the planar state and the focal conic state coexist in a mixed conditions and it is possible to display a gradation.

As indicated by the curve P illustrated in FIG. 2, it is possible to reduce the reflectivity of the cholesteric liquid crystal by increasing the coexistence ratio of the focal conic state as the voltage value of the voltage pulse to be applied is increased in the frame A surrounded by the broken line. Further, as indicated by the curves P and FC illustrated in FIG. 2, it is possible to reduce the reflectivity of the cholesteric liquid crystal as the voltage value to be applied is reduced in the frame B surrounded by the broken line.

In order to display a gradation, the A region or the B region is utilized. When the A region is utilized, after the pixels are initialized and brought into the planar state, a voltage pulse between VF0 and VF100a is applied and part of the pixels is brought into the focal conic state. When the B region is utilized, after the pixels are initialized and brought into the focal conic state, a voltage pulse between VF100b and VP0 is applied and part of the pixels is brought into the planar state.

The principles of a driving method based on the voltage response characteristic described above are explained with reference to FIG. 3A to FIG. 3C.

FIG. 3A illustrates the pulse response characteristic when the pulse width of a voltage pulse is a few tens of ms, FIG. 3B illustrates the pulse response characteristic when the pulse width of a voltage pulse is 2 ms, and FIG. 3C illustrates the pulse response characteristic when the pulse width of a voltage pulse is 1 ms. In each figure, a voltage pulse to be applied to cholesteric liquid crystal is illustrated on the upper side and the voltage-reflectivity characteristic is illustrated on the lower side, and the horizontal axis represents a voltage (V) and the vertical axis represents reflectivity (%). The voltage-reflectivity characteristic in FIG. 3A is illustrated by schematizing the curves P and FC in FIG. 2 and the voltage-reflectivity characteristic in FIG. 3B and FIG. 3C is illustrated by schematizing only the curve P in FIG. 2. As a well-known drive pulse of a liquid crystal, voltage pulse to be used here is a combination of a positive polarity pulse and a negative polarity pulse in order to prevent liquid crystal from deteriorating due to polarization.

As illustrated in FIG. 3A, when the pulse width is great, as illustrated by the solid line, if the initial state is the planar state, the state changes into the focal conic state when the voltage is raised to a certain range and if the voltage is further raised, the state changes into the planar state again. As illustrated by the broken line, when the initial state is the focal conic state, the state gradually changes into the planar state as the pulse voltage is raised.

When the pulse width is great, the voltage pulse, at which the state changes into the planar state whether the initial state is the planar state or the focal conic state, is ±36 V in FIG. 3A. With a pulse voltage in the middle of this range, the state is such that the planar state and the focal conic state coexist in a mixed condition, and therefore, a gradation can be obtained.

On the other hand, when the pulse width is 2 ms as illustrated in FIG. 3B, if the initial state is the planar state, the reflectivity remains unchanged when the voltage pulse is ±10 V. However, at higher voltages, the planar state and the focal conic state coexist in a mixed condition, and therefore, the reflectivity is reduced. The amount of reduction in reflectivity increases as the voltage is increased. However, when the voltage is increased than ±36 V, the amount of reduction in reflectivity becomes constant. This is also the same when the initial state is a state where the planar state and the focal conic state coexist in a mixed condition. Because of this, when the initial state is the planar state, if a voltage pulse having a pulse width of 2 ms and a pulse voltage of ±20 V is applied once, the reflectivity is reduced by a certain amount. In this manner, in the state where the planar state and the focal conic state coexist in a mixed condition and the reflectivity is reduced by a small amount, if a voltage pulse having a pulse width of 2 ms and a pulse voltage of ±20 V is further applied, the reflectivity is reduced further. If this is repeated, the reflectivity is reduced to a predetermined value.

As illustrated in FIG. 3C, when the pulse width is 1 ms, the reflectivity is reduced when a voltage pulse is applied in a manner similar to that when the pulse width is 2 ms. However, the amount of reduction in reflectivity is smaller than when the pulse width is 2 ms.

From the above, it can be thought that if a pulse of 36 V having a pulse width of several tens milliseconds is applied, the state planar state is brought about and if a pulse of about ten-something to 20 V having a pulse width of about 2 ms is applied, the state changes from the planar state into a state where the planar state and the focal conic state coexist in a mixed condition and the reflectivity is reduced, and the amount of reduction in reflectivity depends on the cumulative time of the pulse.

Because of this, in the cholesteric liquid crystal display device, in the first step, an initialization pulse of ±36 V having a pulse width of a few tens of ms is applied to the pixel to be rewritten to bring the pixel into the planar state and in the next second step, a gradation pulse of about ±20.0 V having a narrow pulse width is applied to the pixel to be brought into a gradation and the cumulative application time is set to a value in accordance with the level of the gradation. In other words, this display method utilizes the region A in FIG. 2 to display a gradation level.

In the display device, a plurality of scan electrodes parallel to one another are provided on one of the surfaces of the display material layer and a plurality of data electrodes parallel to one another that intersect the plurality of scan electrodes are provided on the other surface of the display material layer, and then, a pixel is formed at the intersection of the scan electrode and the data electrode. The scan electrode is referred to as a scan line and the data electrode is referred to as a data line. In the display device, a common driver applies a scan pulse to the scan line and a segment driver applies a data pulse to the data line.

In the first step, the pulse is applied to all of the scan lines and all of the data lines at the same time. In the second step, in order to set a gradation level for each pixel, while a scan pulse is being applied to one scan line, the data pulse is applied to all of the data lines, and thereby, a voltage pulse is applied to the pixel in the one scan line. After this, the scan lines to which a scan pulse is applied are shifted sequentially and thus the application of the voltage pulse to the pixels of all of the scan lines is completed.

In the second step, while a selection scan voltage corresponding to the scan pulse is being applied to one scan line, a non-selection scan voltage is applied to the other scan lines. To the data line of the pixel to which a gradation is written, a selection data voltage corresponding to the data pulse is applied and to the data line of the pixel to which a gradation is not written, a non-selection data voltage is applied. Because of this, there exist pixels to which the selection scan voltage and the selection data voltage are applied, pixels to which the non-selection scan voltage and the selection data voltage are applied, pixels to which the non-selection scan voltage and the selection data voltage are applied, and pixels to which the non-selection scan voltage and the non-selection data voltage are applied as a result. It is necessary to set the selection scan voltage, the non-selection scan voltage, the selection data voltage, and the non-selection data voltage so that the reflectivity (gradation) decreases only in the pixel to which the selection scan voltage and the selection data voltage are applied and the reflectivity (gradation) does not decrease in the other three kinds of pixel.

In the display device that utilizes cholesteric liquid crystal, the segment driver and the common driver output, for example, pulses as illustrated in FIG. 4A, as gradation pulses to be applied in order to change the planar state into the gradation level. By applying such pulses, voltages as illustrated in FIG. 4B are applied to the pixels.

To the segment driver, 20 V as V0 and 10 V as V21S and V34S are supplied and a positive pulse is output in the positive polarity phase (FR=1) and a negative pulse is output in the negative polarity phase (FR=0).

To the common driver, 20 V as V0, 15 V as V21C, and 5 V as V34C are supplied and a negative pulse is output in the positive polarity phase (FR=1) and a positive pulse is output in the negative polarity phase (FR=0).

By applying the pulses as illustrated in FIG. 4A, 20 V is applied in the positive polarity phase (FR=1) and −20 V is applied in the negative polarity phase (FR=0) when the scan line is in the selected state (the common driver is ON) and the data line is also in the selected state (the segment driver is ON). When the scan line is in the selected state (the common driver is ON) and the data line is in the non-selected state (the segment driver is OFF), 10 V is applied in the positive polarity phase (FR=1) and −10 V is applied in the negative polarity phase (FR=0). When the scan line is in the non-selected state (the common driver is OFF) and the data line is in the selected state (the segment driver is ON), 5 V is applied in the positive polarity phase (FR=1) and −5 V is applied in the negative polarity phase (FR=0). When the scan line is in the non-selected state (the common driver is OFF) and the data line is in the non-selected state (the segment driver is OFF), −5 V is applied in the positive polarity phase (FR=1) and 5 V is applied in the negative polarity phase (FR=0).

Because of the above, the waveform of the voltage pulse to be applied to each pixel of the scan line in the selected state is as illustrated in FIG. 5A and the waveform of the voltage pulse to be applied to each pixel of the scan line in the non-selected state is as illustrated in FIG. 5B and in both the cases, the waveform of the data line in the selected state is represented by the solid line and the waveform of the data line in the non-selected state is represented by the dotted line. As illustrated in FIG. 3B, in the case of a voltage pulse having a pulse width of 2 ms, when the voltage is ±20 V, the state of liquid crystal, that is, the reflectivity changes. However, when the voltage is ±10 V, the reflectivity does not change, and therefore, with the waveform as described above, writing by a gradation pulse is performed when both the scan line and the data line are ON and writing is not performed otherwise as a result. In actuality, there is a problem of crosstalk. However, its explanation is omitted because it does not relate directly to the embodiments.

As described above, the voltage pulse to be applied actually in the display device has the waveform as described in FIG. 5A and FIG. 5B, however, for the sake of simplification of explanation, the pulse is represented by positive and negative pulses symmetric about 0 V.

As to the multi-gradation display method by cholesteric liquid crystal, there have been proposed various driving methods. The method of driving a multi-gradation display by cholesteric liquid crystal is divided into a dynamic driving method and a conventional driving method.

Japanese Laid-open Patent Publication No. 2001-228459 describes a dynamic driving method. However, the dynamic driving method uses complicated drive waveforms, and therefore, requires a complicated control circuit and a driver IC and also requires a transparent electrode of the panel, having a low resistance, resulting in a problem that the manufacturing cost is increased. Further, the dynamic driving method has a problem that power consumption is large.

Y.-M. Zhu, D-K. Yand, Cumulative Drive Schemes for Bistable Reflective Cholesteric LCDs, SID 98 DIGEST, pp 798-801, 1998 describes a conventional driving method. This non-patent document 1 describes a method of driving the state gradually from a planar state to a focal conic state, or from the focal conic state to the planar state at a comparatively high semi-moving picture rate by making use of the cumulative time inherent in liquid crystal and adjusting the number of short pulses.

When a gradation is set by making use of the cumulative time using the conventional driving method, there can be conceived of a method of adjusting the number of times of application of a short pulse as described in FIG. 6A and a method of varying the pulse width W as illustrated in FIG. 6B. The method of varying the pulse width is more advantageous than the method of adjusting the number of times of application of a short pulse from the standpoint of suppression of power consumption.

Further, there is a method of varying the cumulative time of pulse application by the use of both the pulse width and the number of times of pulse application. FIGS. 7A to 7D are diagrams illustrating an example of voltage pulses used in such a method, also illustrating gradation states that changes when the voltage pulses are applied.

FIG. 7A illustrates an initialization pulse used in the first step and the pulse voltage is ±36 V and the pulse width is comparatively great. By applying this pulse, the liquid crystal of pixel is brought into the planar state, i.e., the maximum gradation state. FIGS. 7B to 7D illustrate first to third gradation pulses used in the second step and the pulse voltage is ±20 V, respectively. However, the pulse width is smaller in the order of the first to the third gradation pulses. When the pulses in FIGS. 7B to 7D are applied, part of the liquid crystal is brought from the planar state into the focal conic state in the pixel and the gradation is reduced, the degree of reduction in gradation being smaller in the order of FIGS. 7B to 7D. In other words, when the pulses in FIG. 7B to 7D are applied, a low gradation, a medium gradation, and a high gradation are obtained relatively. FIG. 7B is referred to as a low gradation pulse, FIG. 7C as a medium gradation pulse, and FIG. 7D as a high gradation pulse. Here, only by applying any one of the pulses in FIGS. 7B to 7D, or by applying no pulse, only four gradations can be represented. However, it is also possible to combine the three kinds of pulse illustrated in FIGS. 7B to 7D. For example, it is possible to represent a number of gradations by forming one line period nT by combining n periods T and selecting the pulse width in each period T. It is also possible to represent a number of gradations by applying the gradation pulse in a plurality of frames and selecting whether or not to apply any one of the pulses in FIG. 7B to 7D in each frame.

FIG. 8 is a diagram illustrating the change in brightness Y (gradation) versus the number of times of application of a low gradation pulse L, a medium gradation pulse M, and a high gradation pulse H (number of pulses). As illustrated schematically, in the case of the high gradation pulse H having a small pulse width, the reduction in brightness per pulse is small and the brightness decreases sequentially in accordance with the number of pulses. In the case of the medium gradation pulse M having a medium pulse width, the reduction in brightness per pulse is greater than that of the high gradation pulse H and the brightness decreases sequentially in accordance with the number of pulses, however, the degree of reduction becomes smaller gradually. In the case of the low gradation pulse L having a great pulse width, the reduction in brightness per pulse is further greater than that of the medium gradation pulse M, however, the brightness hardly decreases when the number of pulses is three or more. This is because the coexistence ratio of the focal conic state reaches saturation.

In the display material, such as liquid crystal, it is known that the viscosity changes and the response properties to a voltage pulse also change depending on temperature. Accordingly, the pulse width and the pulse voltage (wave height) of the initialization that can bring about the planar state also change. It is of course possible to bring about the planar state by using a voltage pulse having a great pulse width and a great wave height, however, this means electric power is consumed more than necessary. Further, there arises a problem that a desired gradation level cannot be achieved even if a predetermined gradation pulse is applied.

FIG. 9 is a diagram explaining an influence by the change of the voltage-reflectivity characteristic of cholesteric liquid crystal due to the change in temperature. Only the characteristic corresponding to the curve P in FIG. 2 is illustrated. As illustrated schematically, it can be seen that the characteristic considerably shifts relative to the points where the A region and the B region relating to the gradation representation are brought into the complete planar state.

Various temperature compensation methods for reducing the influence of the temperature change have been proposed.

Japanese Laid-open Patent Publication No. 2001-100182 describes the adjustment of the pulse width and the wave height (pulse voltage) of the selection voltage pulse in accordance with temperature in the liquid crystal display device in which a gradation is represented by adjusting the number of the selection (gradation) voltage pulses the pulse voltage and the pulse width of which are set in accordance with a gradation level after initializing the cholesteric liquid crystal into the focal conic state by applying the reset (initialization) pulse. In the method described in Japanese Laid-open Patent Publication No. 2001-100182, in order to initialize the state into the focal conic state, the initialization pulse is applied to change the liquid crystal from the focal conic state into the planar state. In order to change the liquid crystal into the planar state, a voltage pulse having a great wave height is applied. However, it is necessary to further increase the wave height when temperature falls, and therefore, there is a problem that power consumption increases considerably. According to the description in Japanese Laid-open Patent Publication No. 2001-100182, the first reset pulse having a large voltage is applied to bring about the homeotropic state before bringing about the focal conic state by applying the second reset pulse. Japanese Laid-open Patent Publication No. 2001-100182 does not describe particularly the temperature compensation of the first and second reset pulses.

Japanese Laid-open Patent Publication No. 2002-268036 describes the adjustment of the pulse width of the voltage pulse in accordance with temperature, which voltage pulse being applied in the selection period during which a gradation state is set, after initializing the cholesteric liquid crystal into the homeotropic state by applying the reset (initialization) pulse. Japanese Laid-open Patent Publication No. 2002-268036 does not describe particularly the temperature compensation of the reset pulse for the initialization into the homeotropic state.

Japanese Patent No. 3714324 describes the temperature compensation by increasing the wave height of the selection pulse and reducing the pulse width when temperature is high and reducing the wave height and increasing the pulse width when temperature is low in the cholesteric liquid crystal display device. This method brings about a problem that power consumption increases considerably when temperature is high.

Japanese Laid-open Patent Publication No. 63-044636 describes the configuration in which the drive pulse period is varied while keeping constant the drive voltage when temperature is low and the drive voltage is varied while keeping constant the drive pulse period when temperature is high in the ferroelectric liquid crystal display device having memory properties. Specifically, the drive voltage is reduced as temperature rises and the pulse period is lengthened as temperature falls. As illustrated in FIG. 9, when a pulse having a pulse width of a certain length is applied, the A region on the way of the transition from the planar state to the focal conic state and the B region on the way of the transition from the focal conic state to the planar state are shifted in accordance with the temperature change, however, the amount of shift due to temperature of the point where the complete planar state is achieved is relatively small. Because of this, if the compensation of the drive voltage (pulse wave height) is applied at temperature equal to or higher than 25° C. as described in Japanese Laid-open Patent Publication No. 63-044636, the wave height is increased as the temperature changes from 50° C. to 35° C. to 25° C. As a result of that, there arises a problem that electric power is consumed wastefully because reset is possible with the same pulse wave height as that at ambient temperature even when temperature falls. However, the pulse wave height is increased. Further, general-purpose parts cannot be used as circuit parts when the drive voltage exceeds 40 V, and therefore, the configuration described in Japanese Laid-open Patent Publication No. 63-044636 has a problem that the cost is increased drastically.

Further, Japanese Laid-open Patent Publication No. 63-044636 describes the driving method that uses a pulse period in accordance with each gradation, however, does not describe specifically how to increase the pulse period as temperature falls.

### SUMMARY

According to a first aspect of the embodiments, a display device includes: a display element of matrix type; a drive circuit that drives a pixel of the display element; a control circuit that controls the drive circuit; and a temperature sensor that detects the temperature of the display device, in which the control circuit controls the drive circuit so that an initialization pulse to initialize a pixel to be rewritten is applied to bring about an initial gradation state and then a gradation pulse is applied to the initialized pixel to bring about a gradation state other than the initial gradation state, the cumulative time during which the gradation pulse is applied is related to the value of the gradation state, the control circuit fixes the pulse voltage of the initialization pulse and varies the pulse width of the initialization pulse in accordance with the temperature detected by the temperature sensor; and varies the pulse width of the gradation pulse when the temperature detected by the temperature sensor is low and varies the pulse voltage of the gradation pulse when the temperature detected by the temperature sensor is high.

According to a second aspect of the embodiments, a driving method of a display element of dot matrix type, includes a first step of applying an initialization pulse to initialize a pixel to be rewritten to bring about an initial gradation state, and a second step of applying a gradation pulse to the pixel initialized in the first step to bring about a gradation state other than the initial gradation state, in which the cumulative time during which the gradation pulse is applied in the second step is related to the value of a gradation state, the pulse voltage of the initialization pulse is fixed and the pulse width of the initialization pulse is varied in accordance with the temperature detected by the temperature sensor, the pulse voltage of the gradation pulse is fixed and the pulse width of the gradation pulse is varied when the temperature detected by the temperature sensor is low and the pulse voltage of the gradation pulse is varied when the temperature detected by the temperature sensor is high.

The object and advantages of the embodiments will be realized and attained by means of the elements and combination particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIGS. 1A and 1B are diagrams explaining a planar state and a focal conic state of cholesteric liquid crystal.

FIG. 2 is a diagram explaining a state change of cholesteric liquid crystal by a pulse voltage.

FIG. 3A is a diagram explaining a change in reflectivity by a pulse having a large voltage and a great pulse width to be applied to cholesteric liquid crystal.

FIG. 3B is a diagram explaining a change in reflectivity by a pulse having a medium voltage and a narrow pulse width to be applied to cholesteric liquid crystal.

FIG. 3C is a diagram explaining a change in reflectivity by a pulse having a medium voltage and a narrower pulse width to be applied to cholesteric liquid crystal.

FIG. 4A is a diagram illustrating a driver output voltage at the time of gradation pulse application.

FIG. 4B is a diagram illustrating a liquid crystal applied voltage at the time of gradation pulse application.

FIG. 5A is a diagram illustrating an example of a symmetric pulse to be applied actually.

FIG. 5B is a diagram illustrating an example of a symmetric pulse to be applied actually.

FIG. 6A is a diagram explaining a configuration to vary a cumulative application time by the number of short pulses.

FIG. 6B is a diagram explaining a configuration to vary the cumulative application time by the pulse width.

FIGS. 7A to 7D are diagrams illustrating examples of an initialization pulse and a plurality of gradation pulses with different pulse widths to be applied to liquid crystal.

FIG. 8 is a diagram illustrating the change in brightness versus the number of the applied gradation pulses in FIGS. 7B to 7D.

FIG. 9 is a diagram explaining the temperature change of the status change curves of cholesteric liquid crystal by the pulse voltage in FIG. 2.

FIG. 10 is a diagram illustrating the change in viscosity by the temperature of cholesteric liquid crystal.

FIG. 11 is a diagram illustrating a laminated structure of a cholesteric liquid crystal element of a color display device in an embodiment.

FIG. 12 is a diagram illustrating a structure of one cholesteric liquid crystal element of a color display device in an embodiment.

FIG. 13 is a diagram illustrating a schematic configuration of a color display device in a first embodiment.

FIG. 14A is a diagram illustrating a position to which a temperature sensor of the color display device in the first embodiment is attached.

FIG. 14B is a diagram illustrating a position to which the temperature sensor of the color display device in the first embodiment is attached.

FIG. 15 is a time chart illustrating the operation of the color display device in the first embodiment.

FIG. 16 is a diagram illustrating the change in pulse width in accordance with the temperature of the initialization pulse and the gradation pulse in the first embodiment.

FIG. 17 is a diagram illustrating the change in pulse voltage in accordance with the temperature of the gradation pulse in the first embodiment.

FIG. 18 is a diagram illustrating power consumption of the display device in the first embodiment in comparison with that in a conventional example.

FIG. 19A is a diagram illustrating a relationship between viscosity and drive energy in order to obtain predetermined response properties of cholesteric liquid crystal, wherein the horizontal axis represents viscosity η.

FIG. 19A is a diagram illustrating a relationship between viscosity and drive energy in order to obtain predetermined response properties of cholesteric liquid crystal, wherein the horizontal axis represents the root of viscosity η.

FIG. 20 is a diagram illustrating a relationship between brightness and drive energy divided by the root of viscosity η in the display device in the first embodiment.

FIG. 21 is a diagram illustrating a relationship between temperature and contrast in the display device in the first embodiment.

FIG. 22A is a diagram illustrating a tone curve at a low temperature in the display device in the first embodiment.

FIG. 22B is a diagram illustrating a tone curve at a room temperature in the display device in the first embodiment.

FIG. 22C is a diagram illustrating a tone curve at a high temperature in the display device in the first embodiment.

FIG. 23 is a diagram illustrating a configuration of the parts of display elements and drivers in a display device in a second embodiment.

FIG. 24 is a diagram illustrating a part related to temperature compensation within a control circuit in the display device in the second embodiment.

FIG. 25 is a time chart illustrating the operation of the display device in the second embodiment.

FIGS. 26A to 26C are diagrams illustrating a timing to read temperature data in the second embodiment.

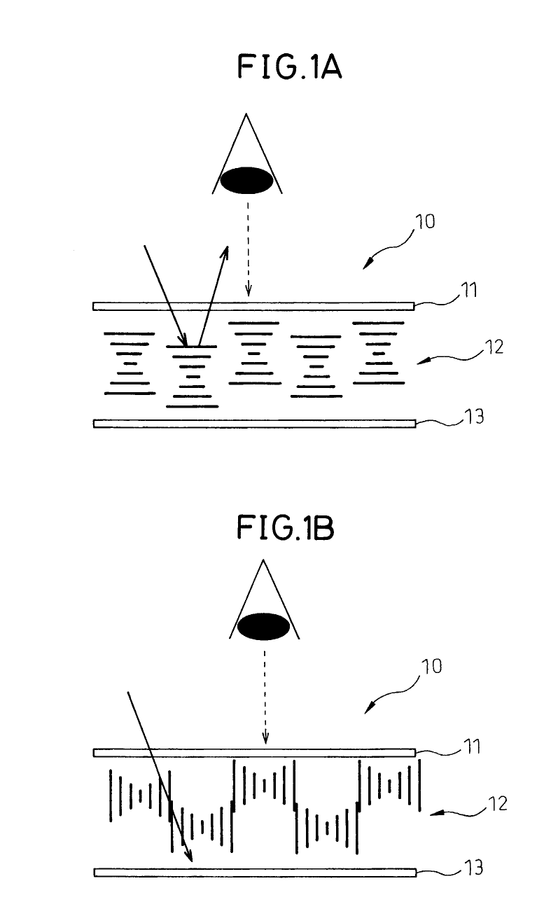

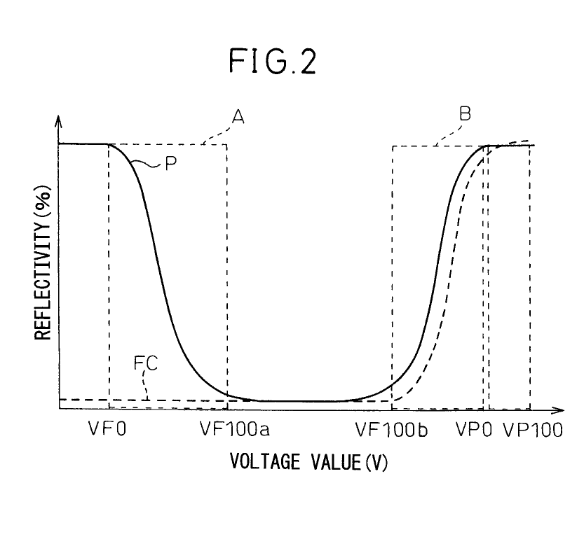

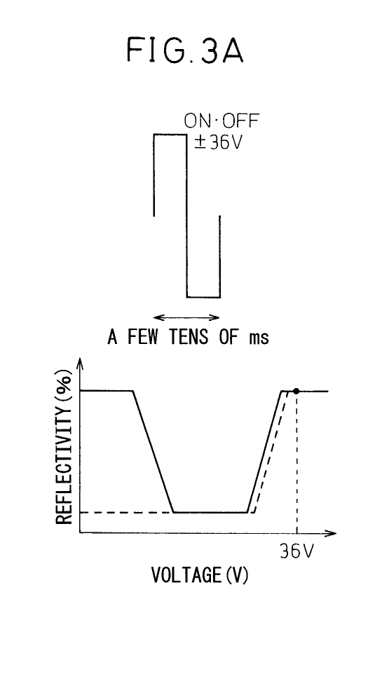

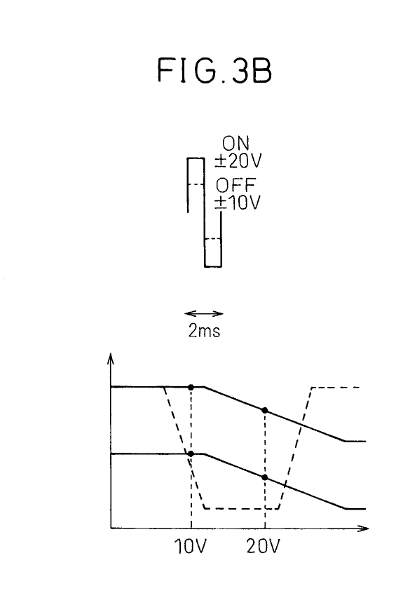

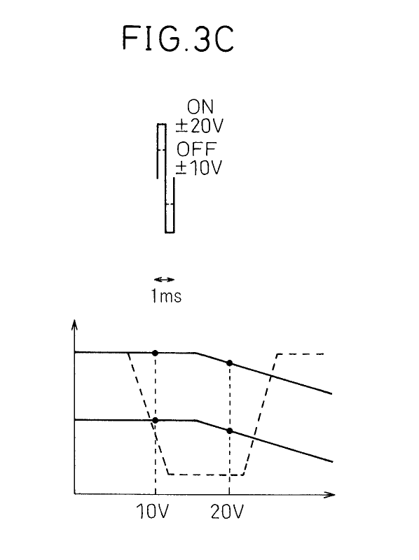

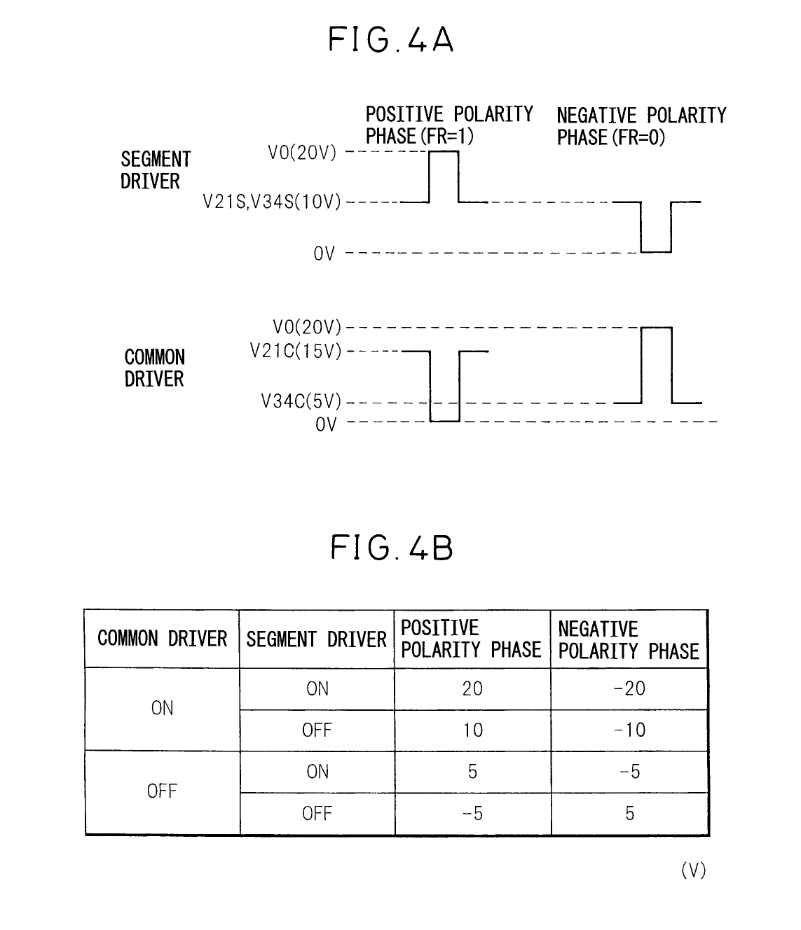

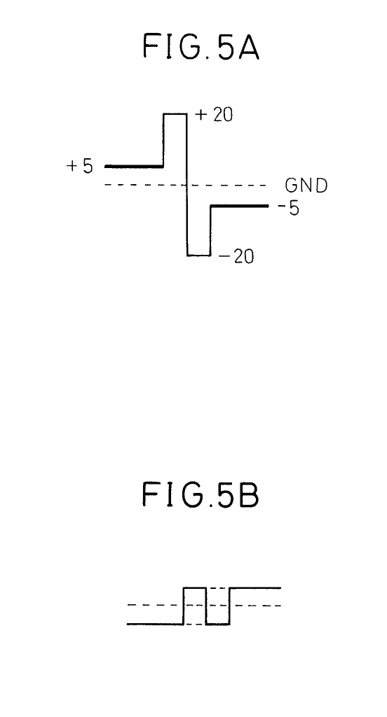

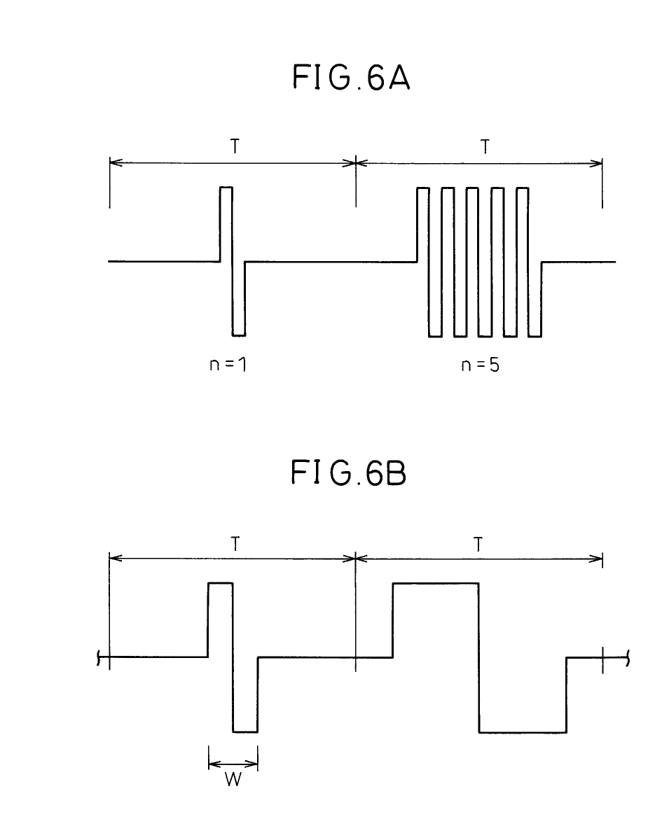

### DESCRIPTION OF EMBODIMENTS

Before the display device and display method in the embodiments are described, the problems of the constitutions disclosed in the above-mentioned documents, which were found by the inventors, are explained.

According to Japanese Laid-open Patent Publication Nos. 2001-100182 and 2002-268036 and Japanese Patent No. 3714324, the pulse voltage and/or the pulse width of the selection (gradation) pulse are adjusted in accordance with temperature change. However, the pulse voltage or the pulse width of the reset (initialization) pulse is not adjusted. Further, Japanese Laid-open Patent Publication No. 63-044636 describes the adjustment of the pulse voltage and the pulse width of the voltage pulse in accordance with temperature change. However, does not described a specific pulse configuration including the reset (initialization) pulse and the gradation pulse.

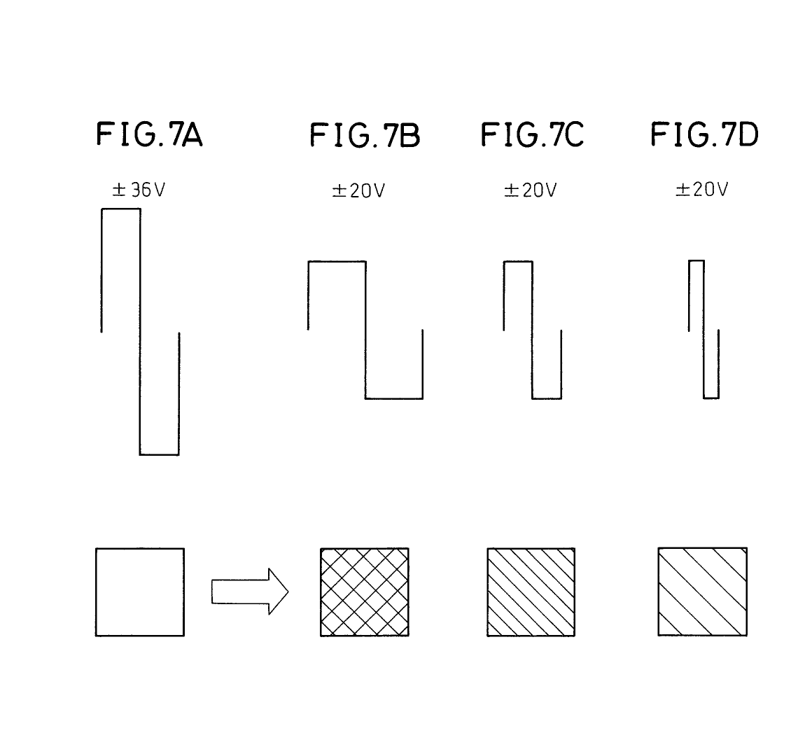

Further, Japanese Laid-open Patent Publication Nos. 2001-100182, 2002-268036, 63-044636 and Japanese Patent No. 3714324 do not describe the configuration of the selection pulse (gradation pulse) by a plurality of voltage pulses having different pulse widths as illustrated in FIGS. 7B to 7D.

On the other hand, in the conventional liquid crystal display device, the response properties (amount of change in the amount of reflection) of liquid crystal are controlled on the assumption that the response properties are in proportion to the product of the pulse voltage and the pulse period. There is known no document that refers particularly to the response properties of a cholesteric liquid crystal display device. However, it can be thought that the same control as that for the conventional liquid crystal display device is performed. However, the inventors have found that a problem arises if the same control as before is performed for a cholesteric liquid crystal display device while we are examining the temperature compensation for the change in the response properties of liquid crystal due to the above-mentioned temperature change.

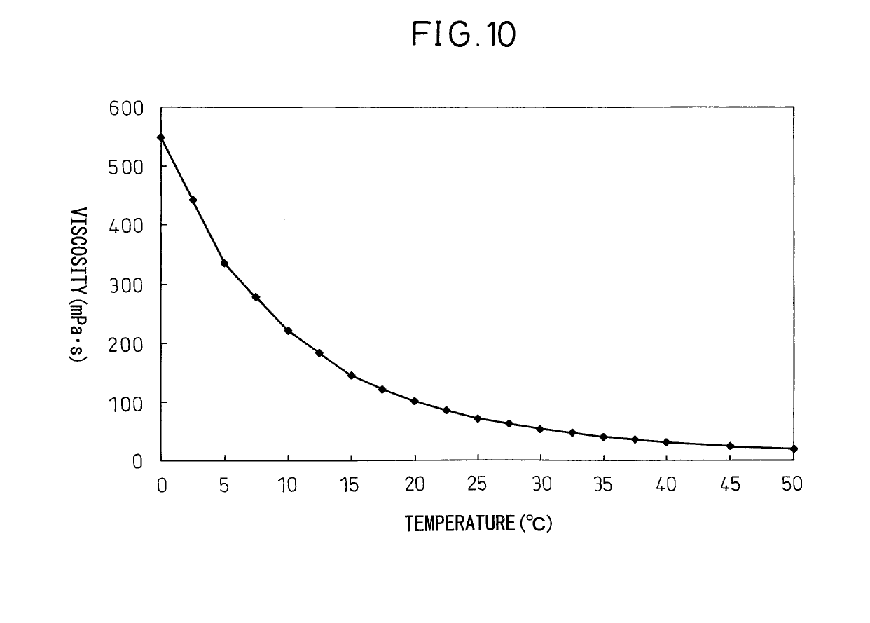

FIG. 10 is a diagram illustrating a relationship between temperature and viscosity of cholesteric liquid crystal. As illustrated schematically, as the temperature falls, the viscosity rises like an exponential function. Generally, it is known that the response speed of liquid crystal is in inverse proportion to the viscosity of the liquid crystal. However, it has been found that, when a plurality of voltage pulses with different pulse widths as illustrated in FIGS. 7B to 7D are applied, if temperature compensation is performed on the assumption that the viscosity of liquid crystal and the pulse period are in a proportional relationship, the variations in the gradation characteristic are large for each temperature, and therefore, the precision of temperature compensation is insufficient.

Next, the temperature dependence of the response properties of cholesteric liquid crystal, which is the premise of embodiments, is explained.

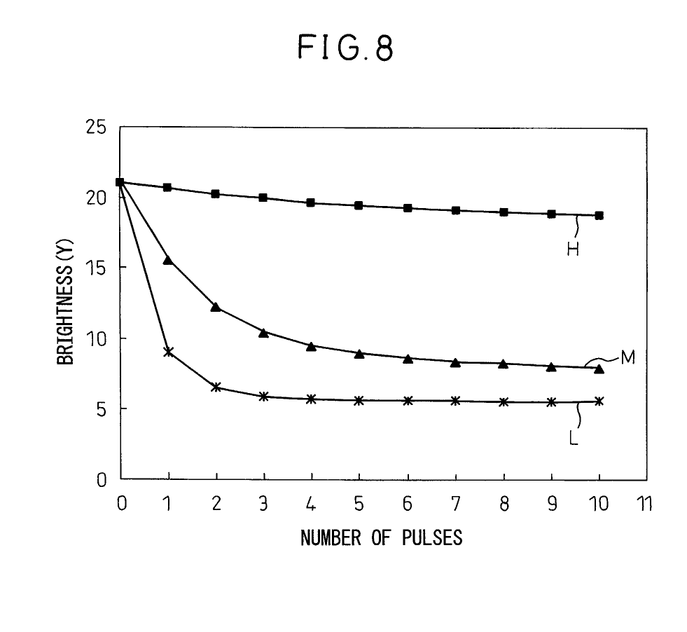

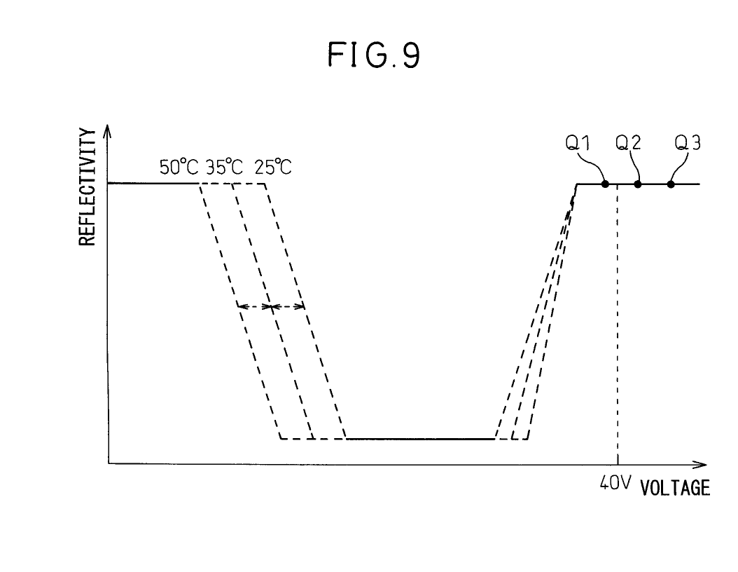

For example, at a room temperature, the gradation characteristic as illustrated in FIG. 8 can be obtained by applying a high gradation pulse, a medium gradation pulse, and a low gradation pulse that constitute the gradation pulse in a cumulative manner after initializing the state into the planar state. Through the studies, the inventors have found that only simply increasing the wave height (pulse voltage) of the high gradation pulse, the medium gradation pulse, and the low gradation pulse in proportion to the viscosity of liquid crystal, or only increasing the pulse width in the same rate is insufficient in order to make the gradation characteristic at low and high temperatures have γ value the same as the gradation characteristic at a room temperature, and that the product of the square of the wave height (pulse voltage) and the period of the pulse width, which is the drive energy to reduce the reflectivity of liquid crystal to produce a gradation, has a high correlation with the root of the viscosity of liquid crystal. Because of this, if temperature compensation is performed based on the relationship, it is possible to perform temperature compensation with an even higher precision.

It has also been confirmed that temperature compensation can be performed sufficiently only by varying the pulse width while keeping constant the pulse wave height (pulse voltage) as to the initialization pulse to initialize the state into the planar state.

The temperature compensation method of the embodiments based on the temperature characteristic described above is explained.

According to the temperature compensation method, after applying an initialization (reset) pulse as illustrated in FIG. 7A to bring about the planar state, a gradation pulse is applied and thus the focal conic state is brought about. The gradation pulse may be composed of the low gradation pulse, the medium gradation pulse, and the low gradation pulse as illustrated in FIGS. 7B to 7D or may be a single pulse the pulse width of which varies by a voltage of ±20 V. In such a driving method, the temperature compensation of the initialization pulse to bring about the planar state is performed by varying the pulse width while keeping constant the pulse voltage, and the temperature compensation of the gradation pulse is performed by varying the pulse width of the gradation pulse when the temperature is low and by varying the pulse voltage of the gradation pulse when the temperature detected by the temperature sensor is high. Specifically, the temperature compensation of the initialization pulse is performed by increasing the pulse width as the temperature falls when the temperature is low. The temperature compensation of the gradation pulse is performed by increasing the pulse width while keeping constant the pulse voltage in the region where the temperature is lower than a predetermined temperature and by reducing the pulse voltage as the temperature rises while keeping constant the pulse width in the region where the temperature is higher than a predetermined temperature.

As described above, the viscosity η of cholesteric liquid crystal changes in accordance with temperature as illustrated in FIG. 8. The temperature compensation of the gradation pulse is performed so that V²×T≈η^{p}×C (where, 0≦p<1, C is constant) holds where V is the wave height of the gradation pulse and T is the pulse width of the gradation pulse after acquiring the viscosity η of cholesteric liquid crystal in accordance with temperature form this relationship. V²×T is the drive energy. From the result of the experiment, the correlation was highest when p was 0.5, however, there was a case where the correlation was highest when p was somewhat shifted from p=0.5 because of somewhat variations due to the plasticity of liquid crystal and the panel structure.

The pulse width of the initialization pulse may be varied across the entire temperature region, however, it may also be possible to fix the pulse width to the value at temperature T when the temperature is higher than, for example, the temperature T (for example, 25° C.).

The predetermined temperature relating to the temperature compensation of the gradation pulse may be set appropriately by taking into consideration the characteristic of the display panel, the capacitance of the power supply circuit, etc.

It may also be possible to vary the pulse voltage and the pulse width stepwise or continuously.

In either case, the gradation pulse is varied while distinguishing the correction by the wave height (pulse voltage) from the correction by the pulse width and the drive energy is varied in a relationship near that in which it is in proportion to the root of the viscosity.

The embodiments are explained below with reference to the drawings.

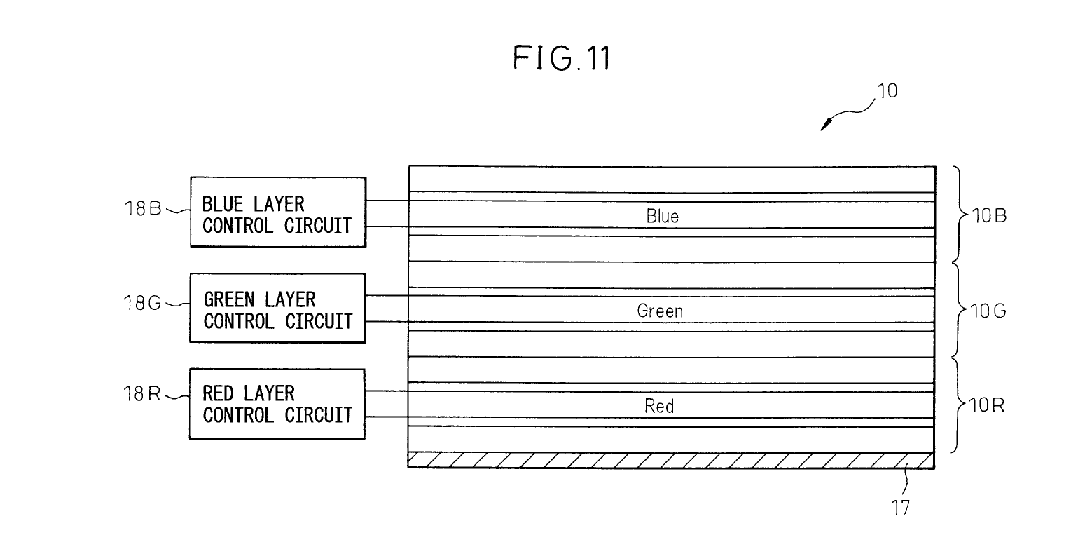

FIG. 11 is a diagram illustrating the configuration of a display device 10 used in the embodiment. As illustrated in FIG. 11, in the display device 10, three panels are stacked into a layer, i.e., a panel 10B for blue, a panel 10G for green and a panel 10R for red in order from the view side, and a light absorbing layer 17 is provided under the panel 10R for red. The panels 10B, 10G and 10R have the same configuration, however, the liquid crystal material and chiral material are selected and the content of the chiral material is determined so that the center wavelength of reflection of the panel 10B is blue (about 480 nm), the center wavelength of reflection of the panel 10G is green (about 550 nm), and the center wavelength of reflection of the panel 10R is red (about 630 nm). The panels 10B, 10G and 10R are driven by a blue layer control circuit 18B, a green layer control circuit 18G and a red layer control circuit 18R, respectively.

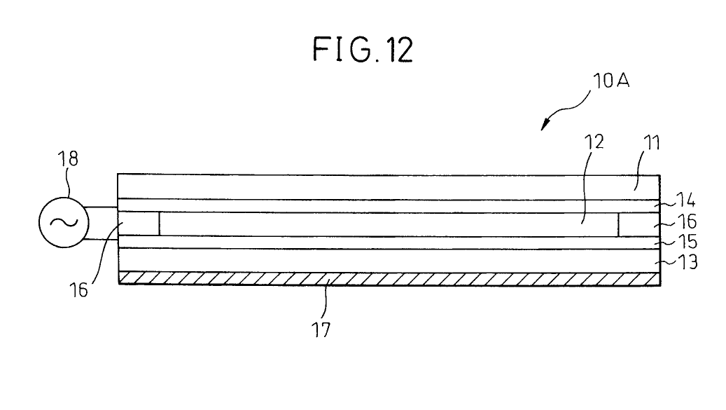

FIG. 12 is a diagram illustrating a basic configuration of the single panel 10A The panel used in the embodiment is explained with reference to FIG. 12.

As illustrated in FIG. 12, the display device 10A has an upper side substrate 11, an upper side electrode layer 14 provided on the surface of the upper side substrate 11, a lower side electrode layer 15 provided on the surface of a lower side substrate 13, and a sealing material 16. The upper side substrate 11 and the lower side substrate 13 are arranged so that the electrodes are in opposition to each other and after a liquid crystal material is sealed in between, they are sealed with the sealing material 16. Within a liquid crystal layer 12, a spacer is arranged. However, it is not illustrated schematically. To the electrodes of the upper side electrode layer 14 and the lower side electrode layer 15, a voltage pulse signal is applied from a drive circuit 18 and due to this, a voltage is applied to the liquid crystal layer 12. A display is produced by applying a voltage to the liquid crystal layer 12 to bring the liquid crystal molecules of the liquid crystal layer 12 into the planar state or the focal conic state.

The upper side substrate 11 and the lower side substrate 13 both have translucency, however, the lower side substrate 13 under the panel 10R does not need to have translucency. Substrates having translucency include a glass substrate, and in addition to the glass substrate, a film substrate of PET (polyethylene terephthalate) or PC (polycarbonate) may be used.

As the material of the electrode of the upper side electrode layer 14 and the lower side electrode layer 15, a typical one is, for example, indium tin oxide (ITO). However, other transparent conductive films, such as indium zinc oxide (IZO), can be used.

The transparent electrode of the upper side electrode layer 14 is formed on the upper side substrate 11 as a plurality of upper side transparent electrodes in the form of a belt in parallel with one another, and the transparent electrode of the lower side electrode layer 15 is formed on the lower side substrate 13 as a plurality of lower side transparent electrodes in the form of a belt in parallel with one another. Then, the upper side substrate 11 and the lower side substrate 13 are arranged so that the upper side electrode and the lower side electrode intersect each other when viewed in a direction vertical to the substrate and a pixel is formed at the intersection. On the electrode, a thin insulating film is formed. If the thin film is thick, it is necessary to increase the drive voltage and it becomes hard to configure the drive circuit by a general-purpose STN driver. Conversely, if no thin film is provided, a leak current flows, and therefore, there arises a problem that power consumption is increased. The dielectric constant of the thin film is about 5, which is considerably lower than that of the liquid crystal, and therefore, it is appropriate to set the thickness of the thin film to about 0.3 μm or less.

The thin insulating film can be realized by a thin film of SiO₂ or an organic film of polyimide resin, acryl resin, etc., known as an orientation stabilizing film.

As described above, the spacer is arranged within the liquid crystal layer 12 and the separation between the upper side substrate 11 and the lower side substrate 13, i.e., the thickness of the liquid crystal layer 12 is made constant. Generally, the spacer is a sphere made of resin or inorganic oxide. However, it is also possible to use a fixing spacer obtained by coating a thermoplastic resin on the surface of the substrate. An appropriate range of the cell gap formed by the spacer is 3.5 μm to 6 μm. If the cell gap is less than this value, reflectivity is reduced, resulting in a dark display, or conversely, if the cell gap is greater than this value, the drive voltage is increased and it becomes hard to drive by a general-purpose driver IC.

The liquid crystal composite that forms the liquid crystal layer 12 is cholesteric liquid crystal, which is nematic liquid crystal mixture to which a chiral material of 10 to 40 weight percent (wt %) is added. The amount of the added chiral material is the value when the total amount of the nematic liquid crystal component and the chiral material is assumed to be 100 wt %.

As the nematic liquid crystal, various liquid crystal materials publicly known conventionally can be used. However, it is desirable to use a liquid crystal material the dielectric constant anisotropy (Δ∈) of which is in the range of 15 to 35. When the dielectric constant anisotropy is 15 or more, the drive voltage becomes comparatively low and if greater than the range, the drive voltage itself is reduced. However, the specific resistance is reduced and power consumption is increased particularly at high temperatures.

It is desirable for the refractive index anisotropy (Δn) to be 0.18 to 0.24. When the refractive index anisotropy is smaller than this range, the reflectivity in the planar state is reduced and when larger than this range, the scattering reflection in the focal conic state is increased and further, the viscosity is also increased and the response speed is reduced.

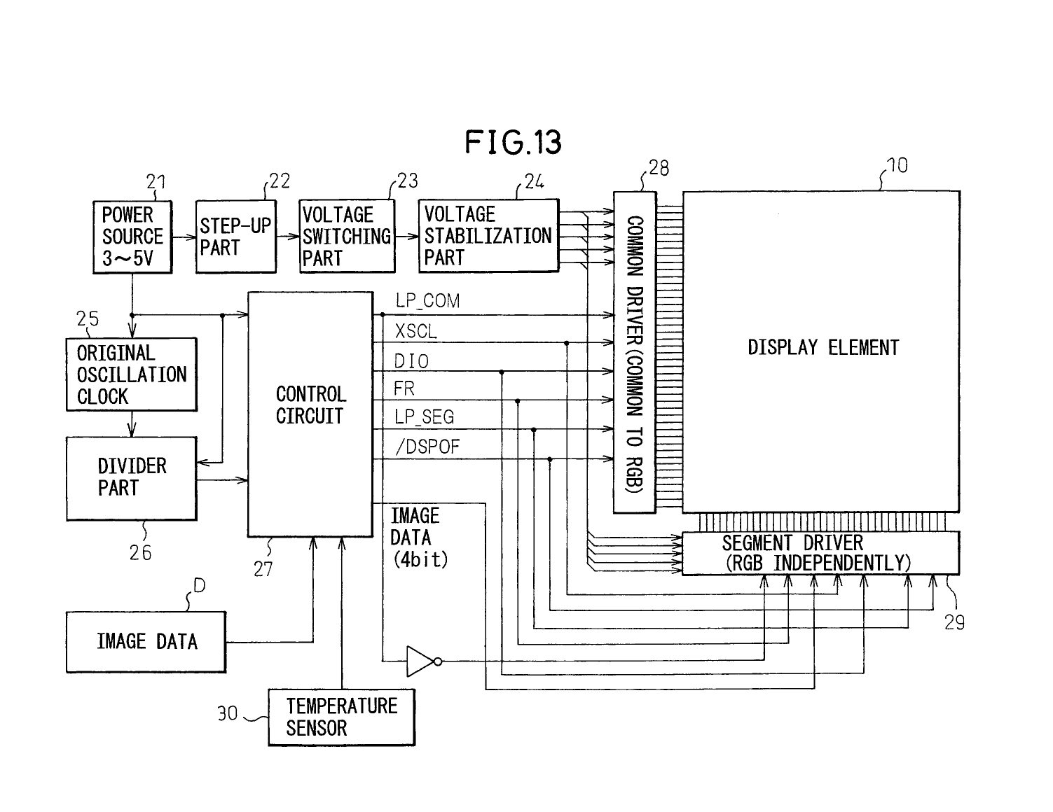

FIG. 13 is a diagram illustrating a configuration of the entire of the display device in a first embodiment of the present embodiment. The display device 10 is in conformity with the A4 size/XGA specifications and has 1,024×768 pixels. A power source 21 outputs a voltage of, for example, 3 V to 5 V. A step-up part 22 steps up the input voltage from the power source 21 to 36 V to 40 V by a regulator, such as a DC-DC converter. As the step-up regulator, a dedicated IC is used widely and the IC has a function to adjust a step-up voltage by setting a feedback voltage. Because of this, it is possible to change the step-up voltage by design a configuration so that a plurality of voltages generated by voltage division by resistor and are selected and supplied to the feedback terminal.

A voltage switching part 23 generates various voltages by resistor division etc. In order to switch between a reset voltage and a gradation write voltage in the voltage switching part 23, an analog switch having a high withstand voltage may be used. However, it is also possible to use a simple switching circuit including a transistor or a D/A converter. It is desirable for a voltage stabilization part 24 to use a voltage follower circuit of an operational amplifier in order to stabilize various voltages supplied from the voltage switching part 23. It is desirable to use an operational amplifier having the characteristics highly resistant to a capacitive load. A configuration is widely known, in which amplification factors are switched by switching resistors connected to the operational amplifier, and if this configuration is used, it is possible to easily switch the voltages to be output from the voltage stabilization part 24.

An original oscillation clock 25 generates a base clock used as a base of the operation. A divider part 26 divides the base clock and generates various clocks necessary for the operation, to be described later.

A control circuit 27 generates a control signal based on the base clock, various clocks and image data D and supplies the signal to a common driver 28 and a segment driver 29. The control circuit 27 adjusts the width of a pulse to be output from the common driver 28 and the segment driver 29 as well as adjusting the step-up voltage of the step-up part 27 or the output voltage of the voltage stabilization part 24 in accordance with the temperature detected by a temperature sensor provided in the display device.

The common driver 28 drives 768 scan lines and the segment driver 29 drives 1,024 data lines. Because image data applied to each RGB pixel is different, the segment driver 29 drives each data line independently.

The common driver 28 drives the lines of RGB commonly. In the present embodiment, a general-purpose STN driver that output two values is used as a driver IC. Various general-purpose STN drivers can be used.

Image data to be input to the segment driver 29 is 4-bit data D0 to D3, which is a full color original image converted into data of RGB each having 16 gradations and 4,096 colors by the error diffusion method. As the gradation conversion method, a method by which high display quality can be obtained is preferable and a blue noise mask method can be used in addition to the error diffusion method.

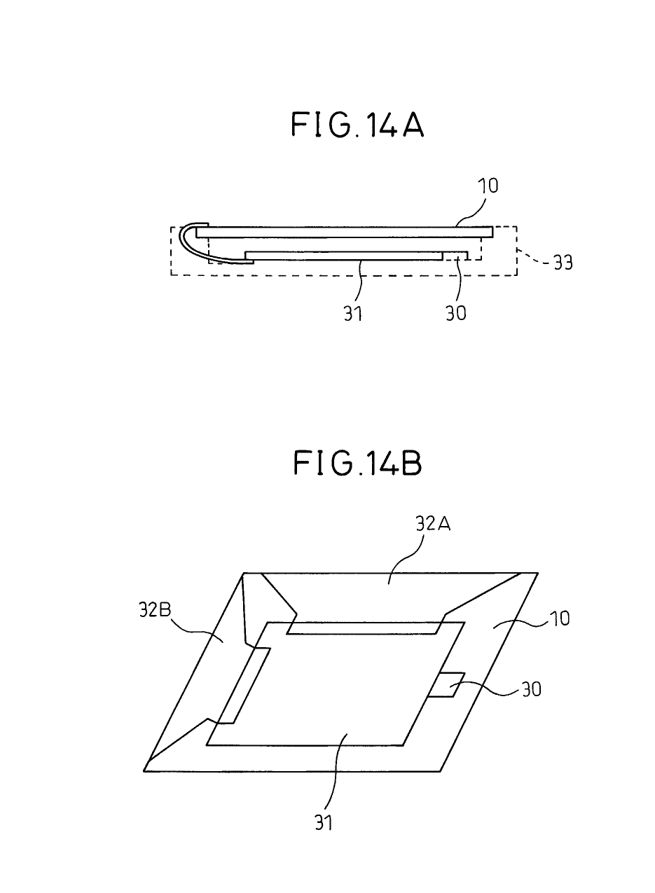

FIG. 14A and FIG. 14B are diagrams illustrating the arrangement of the temperature sensor 30. The display element (display panel) 10 is attached to and held in a housing 33. A circuit substrate on which parts other than the display element in FIG. 13 are mounted is also attached to the housing 33 and arranged on the backside of the display element 10. The display element 10 and the circuit substrate 32 are electrically connected by flexible printed circuit (FPC) boards 32A and 32B. The power source circuit or the control circuit provided on the circuit substrate 32 generates heat when they operate, and therefore, it is desirable for the temperature sensor 30 to be arranged as the position as illustrated schematically, where the temperature sensor 30 is unlikely to be affected. In the examples in FIG. 14A and FIG. 14B, the temperature sensor 30 is arranged at a part projecting from the circuit substrate 32. Due to this, the surround of the temperature sensor 30 is covered with an air layer, and therefore, it is possible to lessen the influence of heat generated in the power source circuit or the control circuit and to further improve the degree of matching between the temperature of the display element 10 and that of the temperature sensor 30. It is also possible to arrange the temperature sensor 30 at a position other than the position illustrated schematically, or to paste onto the backside of the display element 10 and there can be various modified examples.

Next, the image write operation in the present embodiment is explained.

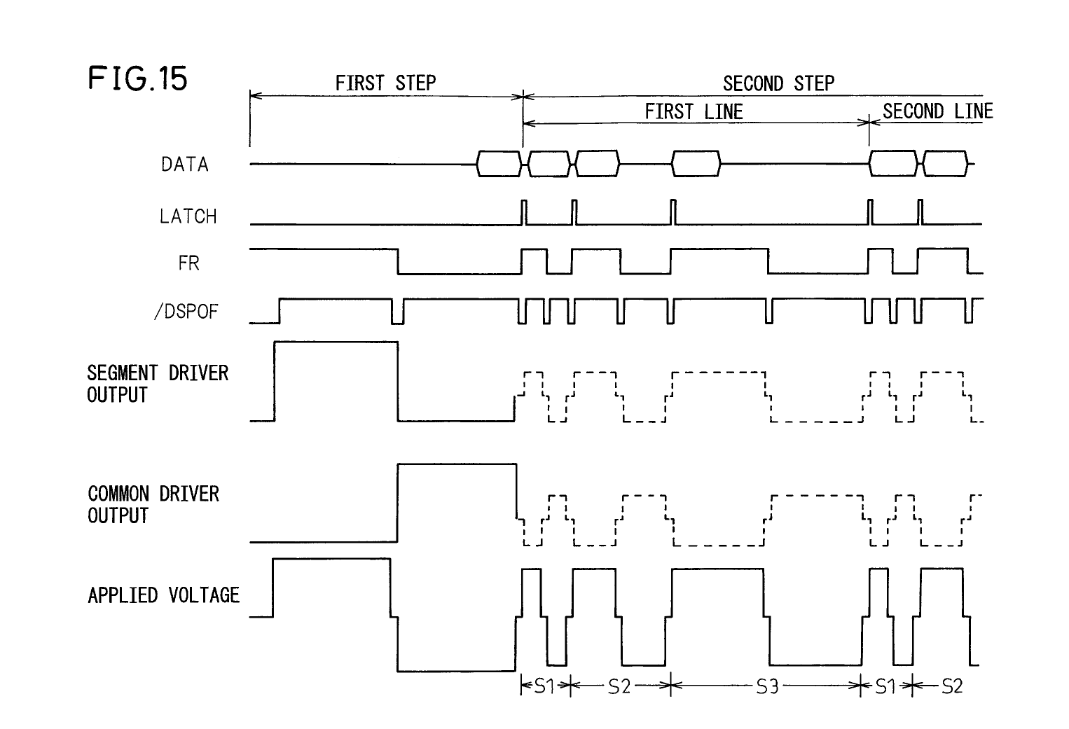

FIG. 15 is a time chart illustrating the image write operation in the present embodiment. The image write operation has a first step of simultaneously applying a pulse of ±36 V to all of the pixels to bring the pixels into the planar state and a second step of selectively applying a gradation pulse to the pixels after the first step to bring about a gradation state where the planar state and the focal conic state coexist in a mixed condition. In the present embodiment, the pulse width is varied by utilizing the output voltage off function (/DSPOF) that the general-purpose STN driver has.

In the first step, after all of the output voltages of the segment driver 29 are set to the ground (GND) level, all of the output lines of the common driver 28 are brought into the selected state. To set all of the output voltages to the GND level, /DSPOF is set to Low (L).

Next, after the polarity signal FR is set to High (H) level, if /DSPOF is set to H level, ±36 V is applied to all of the selected lines and as illustrated in FIG. 12B, all of the pixels enter the homeotropic state.

Next, the polarity signal FR is set to Low level and the voltage applied to all of the lines is inversed from +36 V to −36 V.

In this case, although the appropriate value of the application time of +36 V is different from that of −36 V depending on the configuration of the display element, in the present embodiment, a pulse having a pulse width of 10 ms is used.

Finally, when /DSPOF is set to L and the output is set to 0 V, all of the pixels change from the homeotropic state into the planar state. In this manner, the initialization pulse is applied. By the use of /DSPOF, it is possible to forcedly cause a discharge to occur in the short circuit of the driver IC, and therefore, the time required to charge and discharge the display element can be shortened. The transition to the planer state requires the steepness of the voltage pulse, and therefore, it is possible for the forced discharge using /DSPOF to reset the state into the planar state without fail even if the display element is large in size.

The second step has three sub-steps S1, S2, S3. In the present embodiment, the three sub-steps are performed successively in one frame while one scan line is selected. In the sub-step S1, a high gradation pulse of ±20 V having a narrow pulse width in FIG. 7D is applied selectively, and in the sub-step S2, a medium gradation pulse of ±20 V having a medium pulse width in FIG. 7C is applied selectively, and in the sub-step S3, a low gradation pulse of ±20 V having a great pulse width in FIG. 7B is applied selectively.

As illustrated in FIG. 15, before the first step is ended, data DATA indicative of the pixel of the first line to which a high gradation pulse is applied is transferred to the segment driver 29 and when the transfer of the data is completed and the first step is ended, the segment driver 29 holds the transferred data in accordance with the latch signal LATCH. At this time, the common driver 28 holds scan data indicative of the firs scan line in accordance with the shift signal, now illustrated schematically. After FR is set to H, if /DSPOF is set to H, the common driver 28 applies a scan pulse (0 V) in the positive polarity phase to the first scan line and the segment driver 29 applies a data pulse (20 V) and a non-data pulse (0 V) in the positive polarity phase to the data line in accordance with DATA. No voltage pulse is applied to the other scan lines. After /DSPOF is set to L once, if FR is set to L and /DSPOF is set to H again, the common driver 28 applies a scan pulse (20 V) in the negative polarity phase to the first scan line and the segment driver 29 applies a data pulse (0 V) and a non-data pulse (20 V) in the positive polarity phase to the data line. The sub-step S1 has a period of, for example, 2 ms, and a pulse of ±20 V having a pulse width of about 2 ms is applied.

While sub-step S1 is performed, data DATA indicative of the pixel of the first line to which a medium gradation pulse is applied is transferred to the segment driver 29 and when the first sub-step S1 is ended, the segment driver 29 holds the transferred data in accordance with the latch signal LATCH. After that, the second sub-step S2 is performed in a manner similar to that of the first sub-step S1 and a pulse of ±20 V having a pulse width of about 2 ms is applied. This also applies to the third sub-step S3.

When the sub-steps S1 to S3 for the first scan line in the second step are ended, the sub-steps S1 to S3 in the second step are performed for the second scan line. When this is continued to the last scan line, the write of the enter display element 10 is completed.

By selecting whether or not to apply a voltage pulse in the sub-steps S1 to S3, respectively, it is possible to set eight kinds of cumulative application time, and therefore, eight gradations can be realized. If it is possible to vary the pulse width of the voltage pulse in the sub-steps S1 to S3, the number of gradation levels that can be represented increases accordingly.

In the time chart in FIG. 15, an example is illustrated, in which the sub-steps S1 to S3 in the second step are performed successively for each scan line. However, it is also possible to perform the sub-steps S1 to S3 in the second step separately in three frames F1, F2 and F3, respectively.

In the present embodiment, the initialization pulse and the gradation pulses including the three kinds of pulse (high gradation pulse, medium gradation pulse, and low gradation pulse) are applied in accordance with the time chart illustrated in FIG. 15, and in accordance with the temperature detected by the temperature sensor 30, the pulse width of the initialization pulse and the pulse width and the pulse voltage of the three kinds of pulse (high gradation pulse, medium gradation pulse, and low gradation pulse) are adjusted.

As described above, the temperature compensation of the initialization pulse is performed by varying the pulse width while keeping the pulse voltage to a fixed value. The pulse width of the initialization pulse is increased as the temperature falls across the entire temperature range.

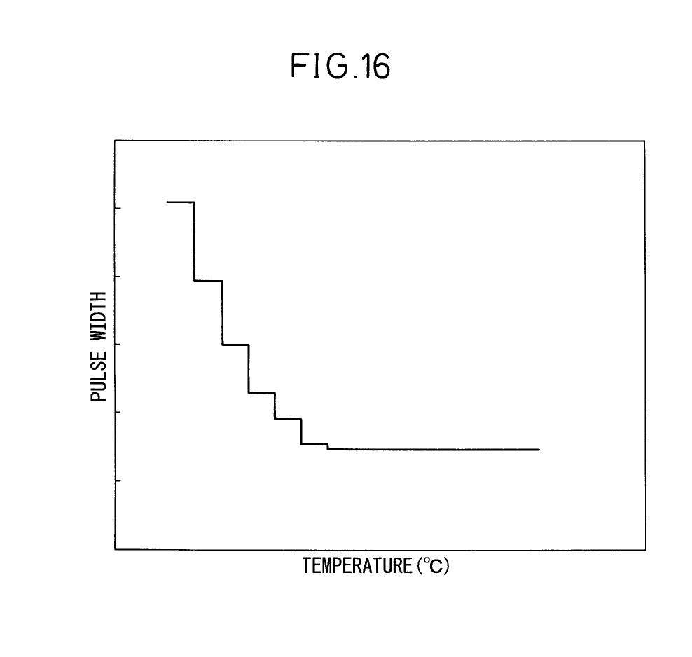

However, as illustrated in FIG. 16, at a predetermined temperature or less, the pulse width of the initialization pulse is increased as the temperature falls. However, it may also be possible to maintain the pulse width at the predetermined temperature at temperatures equal to or higher than the predetermined temperature (for example, 25° C.)

The temperature compensation of the gradation pulse is performed by varying the pulse width of the gradation pulse at low temperatures or by varying the pulse voltage of the gradation pulse at high temperatures. Specifically, in the region where the temperature is lower than a predetermined temperature (for example, 25° C.), the temperature compensation is performed by increasing the pulse width while keeping the pulse voltage to a fixed value and in the region where the temperature is higher than the predetermined temperature, the pulse width is kept constant and the pulse voltage is reduced as the temperature rises. At this time, a viscosity η of the cholesteric liquid crystal in accordance with the temperature is acquired and the temperature compensation of the gradation pulses (high gradation pulse, medium gradation pulse, and low gradation pulse) is performed so that V²×T≈η^{1/2}×C (here, C is constant) holds, where V denotes the pulse voltage of the pulse and T the pulse width.

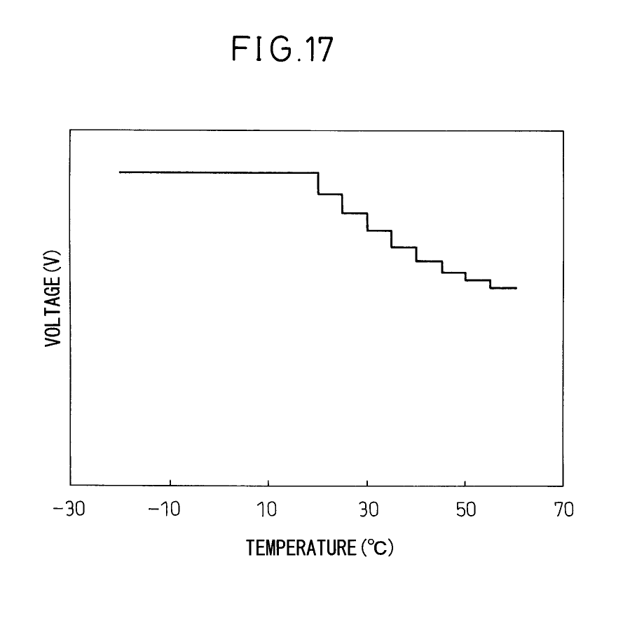

For example, as to the pulse width, although the scale is different from the case of the initialization pulse, the pulse width of the high gradation pulse, the medium gradation pulse, and the low gradation pulse is increased as the temperature falls and at a temperature equal to or high than a predetermined temperature (for example, 25° C.), the pulse width at the predetermined temperature is maintained as illustrated in FIG. 16. As to the pulse voltage, as illustrated in FIG. 17, it may also be possible to maintain the pulse voltage of the high gradation pulse, the medium gradation pulse, and the low gradation pulse at a temperature equal to or lower than the predetermined temperature and reduce the pulse voltage of the high gradation pulse, the medium gradation pulse, and the low gradation pulse at a temperature equal to or higher than the predetermined temperature.

In the RGB laminated type cholesteric liquid crystal display device having the XGA specifications in the present embodiment explained as above, the configuration is such that the display element 10 can be initialize at ±36 V, and therefore, it is possible to use inexpensive general-purpose parts with a low withstand voltage as circuit parts. Further, in the above explanation, the example is explained, in which the three kinds of gradation pulse are used, that is, the high gradation pulse, the medium gradation pulse, and the low gradation pulse. However, in actuality, four kinds of gradation pulse having different pulse widths are used, and therefore, the display device can produce a 4096-color display of 16 gradations for each of RGB.

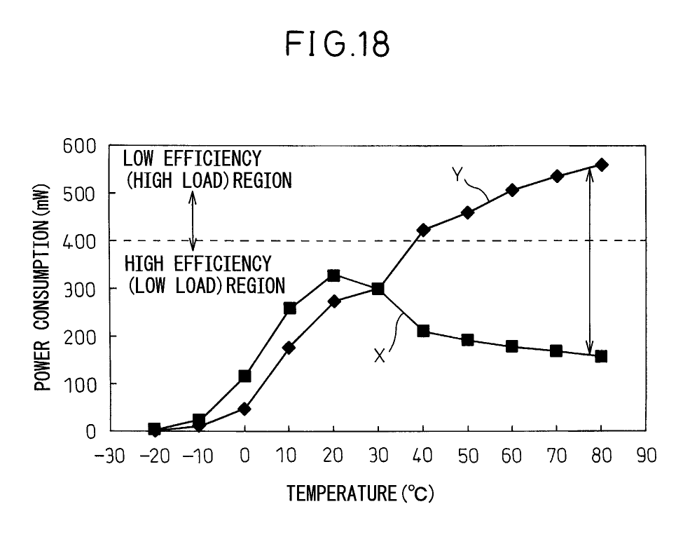

FIG. 18 is a diagram illustrating changes in power consumption versus temperature change when the temperature compensation control in the present embodiment is applied in the display device having the above-mentioned configuration and when the conventional temperature compensation control described Japanese Laid-open Patent Publication No. 2002-268036 or Japanese Patent No. 3714324 is applied, in which the pulse width is simply varied. Reference symbol X denotes the change in power consumption according to the present embodiment and Y denotes that according to the conventional example. According to the conventional example, the power consumption increases as the temperature rises and the power consumption exceeds 400 mW at temperatures higher than 40° C. In contrast to this, according to the present embodiment, compensation is performed so that the pulse voltage is reduced at high temperatures, and therefore, the power consumption is suppressed at high temperatures and the power consumption does not exceed 400 mW.

As the power consumption of the display device increases, the load of the power supply circuit increases, and in particular, the step-up efficiency rapidly decreases when the step-up voltage exceeds a few tens of volts, and therefore, the circumstances become worse and worse for the power consumption. For example, the range where the power consumption exceeds 400 mW is a range where the load is high and the efficiency is low and the region where the power consumption does not exceed 400 mW is a range where the load is low and the efficiency is high, and it is important to remain below the boundary. In the present embodiment, however, the pulse voltage is reduced with the pulse width fixed on the high temperature side, and therefore, the power consumption at high temperatures decreases conversely. At low temperatures also, the increase in voltage due to the increase in pulse voltage is kept to minimum by increasing the pulse width.

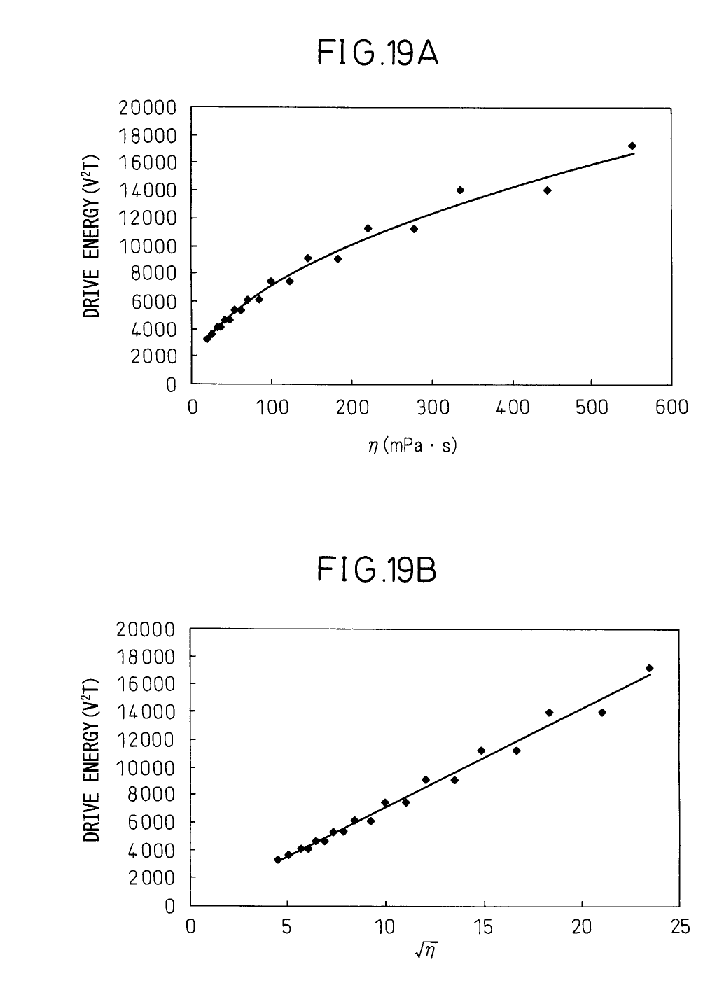

FIG. 19A and FIG. 19B are diagrams illustrating a relationship between viscosity to obtain predetermined response properties (amount of reduction in reflectivity) and drive energy of the gradation pulse (high gradation pulse, medium gradation pulse, low gradation pulse), wherein the horizontal axis represents the viscosity η and the vertical axis represents the drive energy (V²T) in FIG. 19A, and the horizontal axis represents the viscosity η^{1/2} and the vertical axis represents the drive energy (V²T) in FIG. 19B. Here, V represents the pulse voltage (wave height) of the gradation pulse and T represents the pulse width of the gradation pulse.

It can be seen that the relationship is FIG. 19B is more proportional than that in FIG. 19A. Because of this, it can be seen that it is desirable to perform the temperature compensation control so that the value of the drive energy divided by the viscosity η^{1/2} is constant when the viscosity of the liquid crystal changes due to the temperature change.

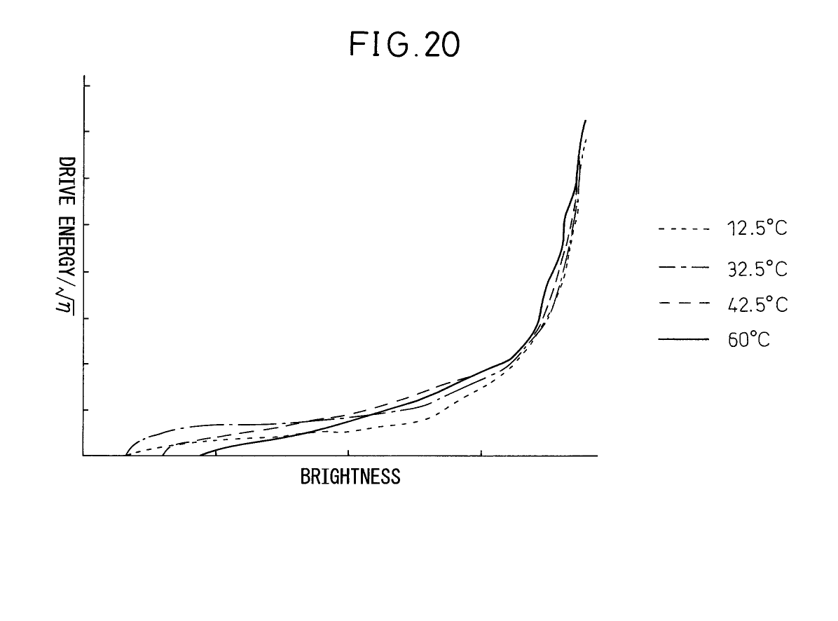

FIG. 20 illustrates a graph of the brightness (lightness) of the display element versus the value of the drive energy divided by the viscosity η^{1/2} in the cholesteric liquid crystal display device in the present embodiment and the vertical axis represents the value of the drive energy of the gradation pulse required to attain a certain brightness divided by the viscosity η^{1/2}. From FIG. 20, it can be seen that the curves of each temperature with different viscosities substantially match one another and the correlation with the root of the viscosity is high.

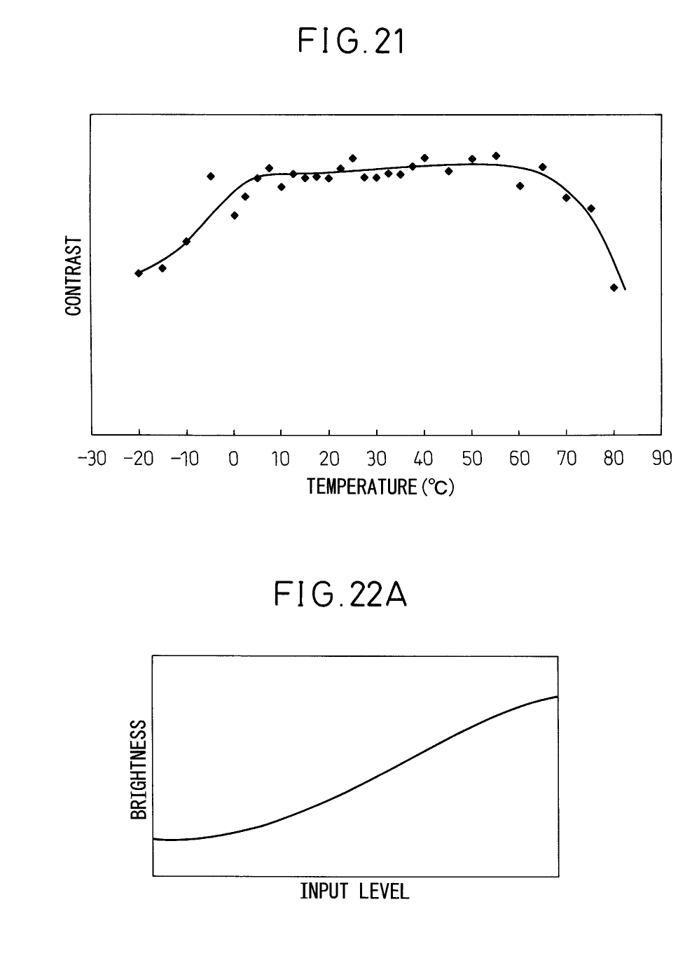

FIG. 21 is a diagram illustrating the change in contrast of the display for the temperature change in the cholesteric liquid crystal display device in the present embodiment. As illustrated in FIG. 21, it can be seen that the contrast slightly depends of temperature and a stable contrast can be obtained across a wide temperature range. In particular, it is possible to stably obtain a high contrast in a temperature range from 0° C. to 50° C., which is regarded as a general operating temperature range. It has been found that the reduction in contrast at temperatures lower than 0° C. and at temperatures higher than 50° C. is inherent in the properties of the display element and does not directly relate to the precision of the temperature compensation.

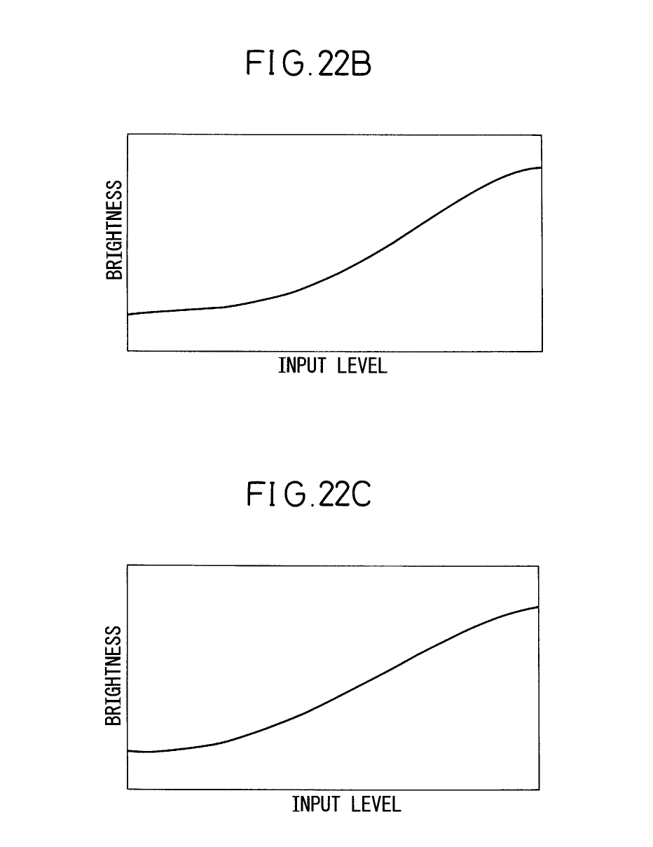

FIG. 22A to FIG. 22C illustrate tone curves when a plurality of gradations corresponding to image data from white to black are displayed in the cholesteric liquid crystal display device in the present embodiment, wherein FIG. 22A illustrates a tone curve at a temperature of 0° C., FIG. 22B illustrates a tone curve at a temperature of 25° C., and FIG. 22C illustrates a tone curve at t temperature of 50° C. From these figures, it can be seen that a stable tone curve can be obtained at each temperature.

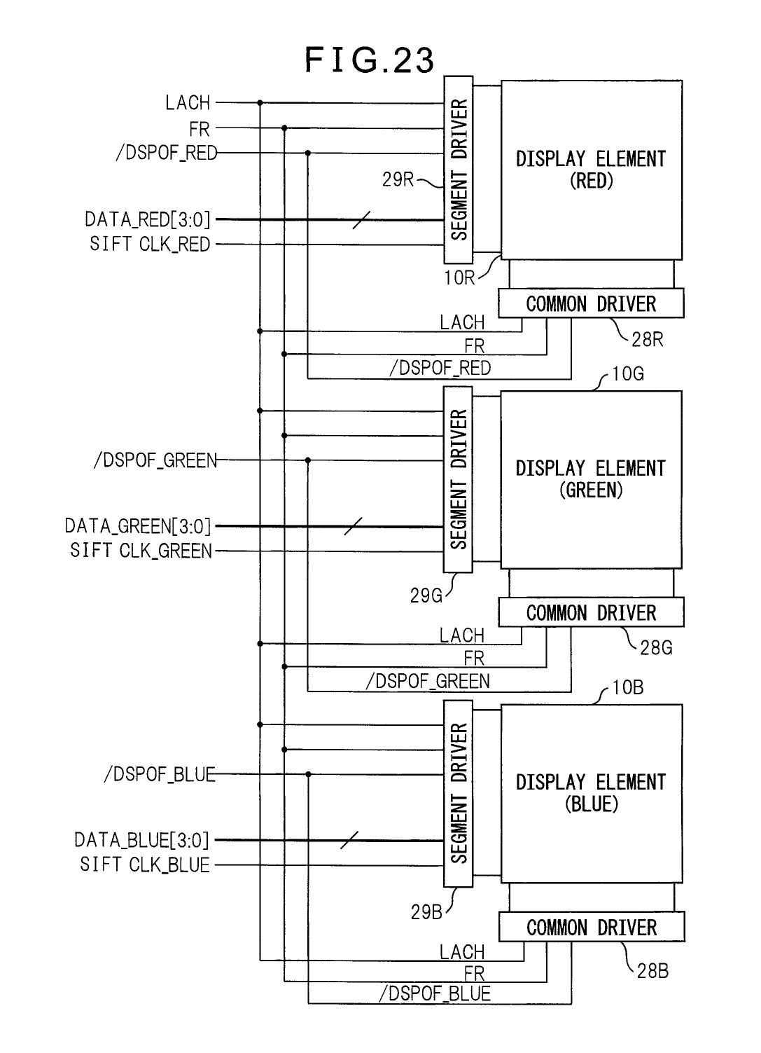

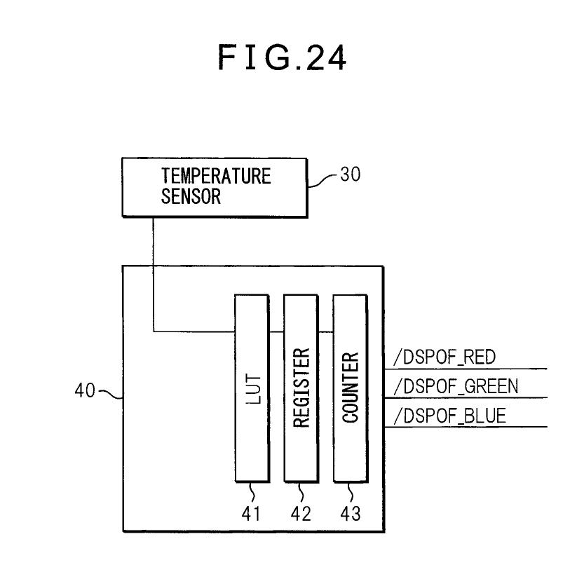

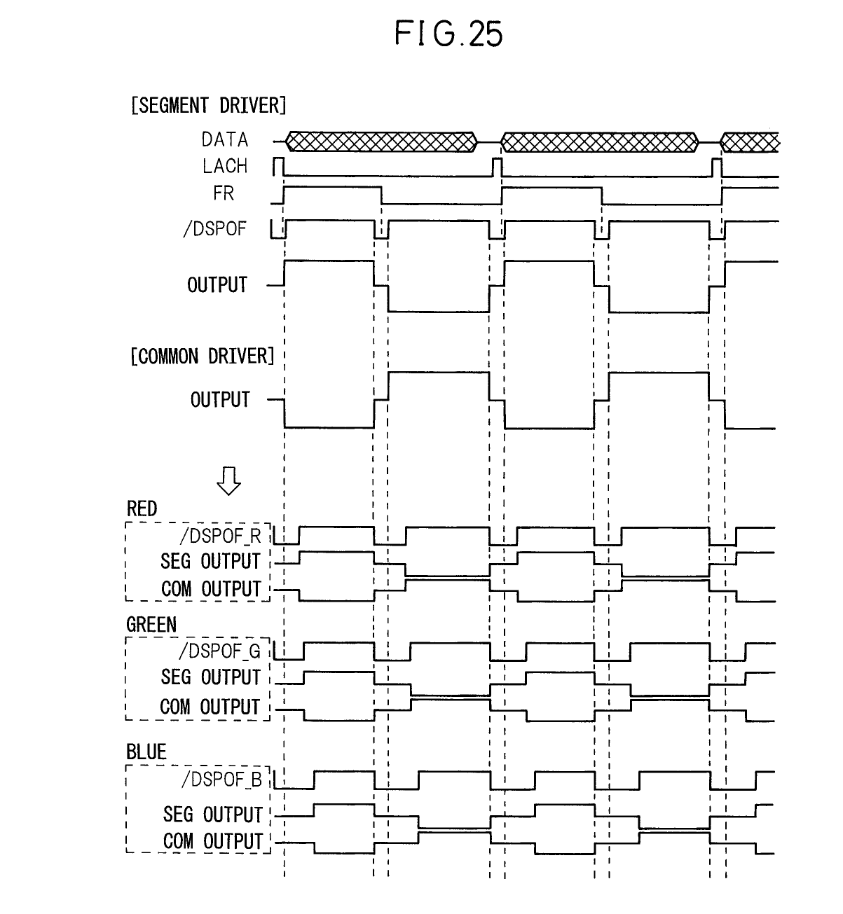

FIG. 23 and FIG. 24 are diagrams each illustrating a configuration of a cholesteric liquid crystal display device in a second embodiment, wherein FIG. 23 illustrates a part of display elements and drivers and FIG. 24 illustrates a configuration of a part that performs control based on the temperature detected by the temperature sensor 30 provided within the control device 27. FIG. 25 is a time chart illustrating an image write operation in the second embodiment. In the second embodiment, the pulse voltage and the pulse width of a voltage pulse to be applied to the panels of three layers of RGB are controlled independently. Other parts of the second embodiment are basically the same as those in the first embodiment.

As illustrated in FIG. 13, in the first embodiment, the common diver 28 commonly drives the scan electrodes of the three layers of RGB, that is, the panels 10R, 10G, 10B of the display element 10. However, in the second embodiment, the scan electrodes of the panels of the three layers of RGB are driven independently by three common drivers 28R, 28G, 28B, respectively. Further, as illustrated in FIG. 24, within the control circuit 27, a lookup table 41 is provided, which stores data about the pulse voltage and the pulse width of the voltage pulse (initialization pulse, gradation pulse (high gradation pulse, medium gradation pulse, low gradation pulse)) to be applied to the panels of the three layers of RGB in accordance with temperature. From the lookup table 41, data of the pulse voltage and the pulse width of the voltage pulse to be applied to the panels of the three layers of RGB in accordance with the temperature detected by the temperature sensor 30 is read into a register 42. The control circuit 27 controls the step-up part 22 and the voltage stabilization part 24 based on the data of the pulse voltage that is read into the register 42. The data of the pulse width that is read into the register 42 is input to a counter 43 and the counter 43 generates /DSPOF_RED that controls the ON/OFF of the output of the segment driver 29R and the common driver 28R that drive the panel 10R, /DSPOF_GREEN that controls the ON/OFF of the output of the segment driver 29G and the common driver 28G that drive the panel 10G, and /DSPOF_BLUE that controls the ON/OFF of the output of the segment driver 29B and the common driver 28B that drive the panel 10B.

In order to change the voltage of the gradation pulse in accordance with temperature, when the second step is performed, the control part 27 reads data corresponding to the temperature detected by the temperature sensor 30 from the LUT 41 and controls so that the voltage stabilization part 24 outputs a corrected voltage.

As described above, in a general-purpose driver for liquid crystal, an output voltage OFF function (/DSPOF) that turns off all of the output voltages is provided normally, and in the second embodiment also, the pulse width of the initialization pulse and the gradation pulse is varied by utilizing this function.

The time chart in FIG. 25 illustrates only part of the second step. In the second embodiment, one gradation pulse is applied while one scan line is selected. Because of this, the plurality of sub-steps constituting the second step are performed in different frames. The frame in which each sub-step is performed is referred to as a write phase here.

As illustrated in FIG. 25, for /DSPOF_RED, /DSPOF_GREEN and /DSPOF_BLUE, the period of time during which they are at H is adjusted independently of each another in accordance with the detected temperature and they are applied to the segment driver 29R and the common driver 28R, the segment driver 29G and the common driver 28G, and the segment driver 29B and the common driver 28B. In response to this, the period of time during which each driver outputs a voltage, i.e., the pulse width, is controlled.

By providing /DSPOF for each driver of RGB, it is possible to perform temperature compensation with high precision including the difference of the temperature dependence between the three kinds of panel of RGB. For example, when the pulse response properties of RED are reduced most at low temperatures, the assert time of /DSPOF is made shortest for BLUE and then that is made longer for GREEN and made further longer for RED as illustrated in FIG. 25, and thus, the pulse width of REG is made longest and it is possible to obtain the same response properties for the three kinds of panel of RGB.

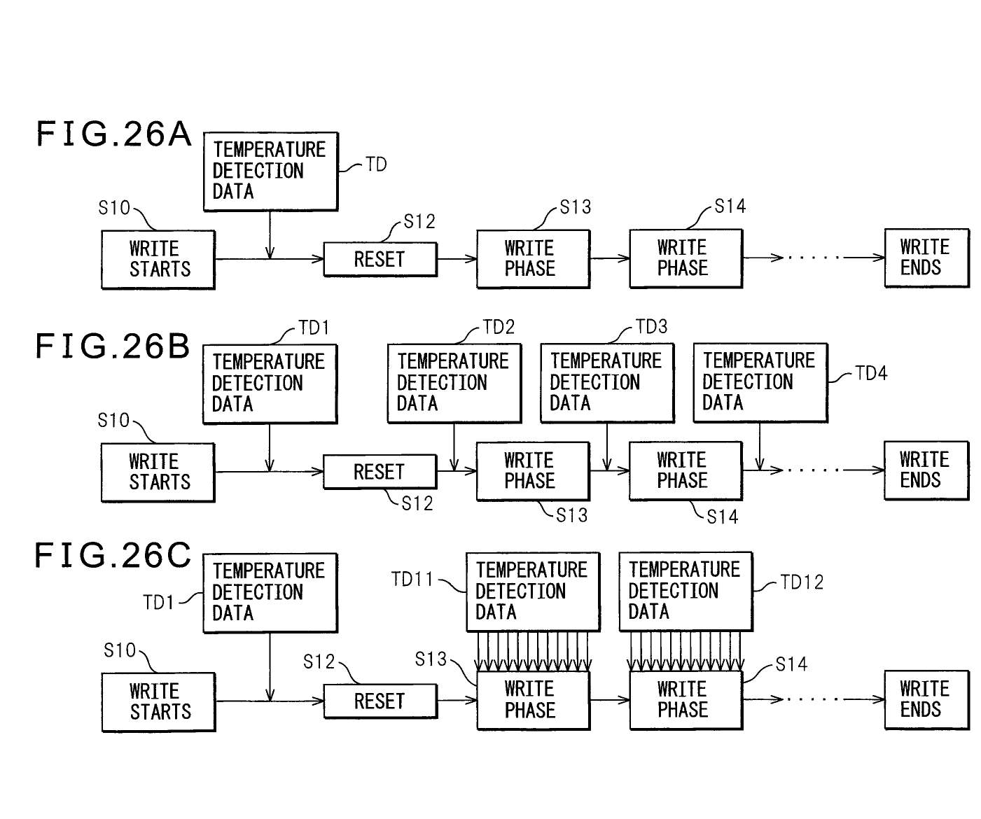

FIGS. 26A to 26C are diagrams explaining the timing at which the temperature sensor detects temperature. As illustrated in FIG. 26A, when a write step S10 is initiated, temperature detection data TD is read and initialization processing (reset) S12, a write phase S13 for performing the first sub-step, and a phase S14 for performing the second sub-step are performed, i.e., the sub-steps to the last one are performed using the pulse width and the pulse voltage corrected based on the temperature data TD.

In the case of FIG. 26A, the load of the control circuit 27 is smallest. However, there is a problem that the compensation precision is reduced when, for example, the temperature changes rapidly during the period of write.

When the write step S10 is initiated as illustrated in FIG. 26B, temperature detection data TD1 is read and the initialization processing (reset) S12 is performed using the pulse width corrected based on the temperature data TD1. After S12, temperature detection data TD2 is read again and the phase S13 is performed using the pulse width and the pulse voltage corrected based on the temperature detection data TD2. After that, similarly, hereinafter, temperature detection data TD3 is read and the write phase S14 is performed, and so on, and thus temperature detection data is read before each write phase and the pulse width and the pulse voltage are corrected based on the temperature repeatedly.

In the case of FIG. 26B, the temperature compensation precision is improved compared to the control in FIG. 26A. However, the load of the control circuit 27 is increased.

FIG. 26C illustrates a case where the temperature detected for each scan line is read in each write phase. With this configuration, compensation can be performed despite the presence of a panel temperature distribution and the temperature compensation precision is highest. However, the load of the control circuit 27 is further increased.

The employment of either of the temperature read timings illustrated in FIGS. 26A to 26C is selected appropriately by the aspect of the product or the application.

As explained above, according to the embodiments, it is possible to realize temperature compensation with high precision with an inexpensive part configuration of low power consumption in a cholesteric liquid crystal display device

The embodiments are described as above, however it is obvious that there can also be various other embodiments. For example, the embodiments can be applied to a display element of dot matrix type having memory properties in addition to the display element that uses cholesteric liquid crystal.

As described above, according to the embodiments, a method of driving a display device and a display element in which power consumption is not increased are realized, and the cost of the device is low, and temperature compensation is performed more precisely.

The method of driving a semiconductor device and a display element of dot matrix type of the embodiments includes the steps of detecting the temperature of a display device using a temperature sensor, varying the pulse width of an initialization pulse in accordance with the temperature detected by the temperature sensor while keeping constant the pulse voltage of the initialization pulse, varying the pulse width of a gradation pulse when the temperature detected by the temperature sensor is low, and varying the pulse voltage of the gradation pulse when the temperature detected by the temperature sensor is high.

According to the embodiments, it is possible to perform temperature compensation more accurately to reduce power consumption because the initialization pulse is also an object of temperature compensation. Moreover, the pulse voltage of the initialization pulse is fixed and only the pulse width of the initialization pulse is adjusted, and therefore, an increase in power consumption is small even when the temperature is low. Specifically, the lower the temperature, the greater the pulse width of the initialization pulse is made. Further, when the temperature is low, the pulse voltage of the gradation pulse is fixed and the pulse width of the gradation pulse is varied, and when the temperature is high, the pulse width of the gradation pulse is fixed and the pulse voltage of the gradation pulse is varied. Specifically, the pulse voltage is reduced as the temperature rises, and therefore, the power consumption is not increased. Because of this, it is not necessary to use a driver IC having a large withstand voltage and a general-purpose driver IC can be used, and therefore, it is unlikely that the cost is increased.

As illustrated in FIGS. 7B to 7D, when a gradation pulse is configured by a plurality of sub gradation pulses with different pulse widths, the pulse width of each sub gradation pulse of the plurality of sub gradation pulses is varied when the temperature is low and the pulse voltage of each sub gradation pulse is varied when the temperature is high, similarly as described above.

The initial gradation state of the display material having memory properties, when it is cholesteric liquid crystal, is the planar state and a gradation state other than the initial gradation state is a state where the planar state and the focal conic state coexist in a mixed condition, and the value of a gradation is determined by the coexistence ratio of the planar state and the focal conic state and it is desirable for a gradation pulse to be configured so that the coexistence ratio is increased.

As described above, in the conventional liquid crystal display device that utilizes twist nematic liquid crystal etc., the response properties (amount of change in the amount of reflection etc.) of liquid crystal are controlled on the assumption that the response properties are in proportion to the product of the pulse voltage and the pulse period. However, the inventors have found that the response properties of cholesteric liquid crystal relate to the product of the square of the pulse voltage and the pulse period.

It is generally known that the response speed of liquid crystal is in inverse proportion to the viscosity of the liquid crystal. However, it has been found that this relationship does not hold in cholesteric liquid crystal, and temperature compensation cannot be performed accurately by the control of the pulse voltage and the pulse width on the assumption that the response speed is simply in inverse proportion to the viscosity.

Specifically, it has been found that the precision of temperature compensation is improved by controlling the wave height and the pulse width of the gradation pulse so that V²×T is substantially in proportion to η^{P} (here, 0≦p<1), more specifically, p assumes a value near 0.5, where η is the viscosity of cholesteric liquid crystal that changes in accordance with temperature, V is the wave height of the gradation pulse, and T is the pulse width of the gradation pulse.

It is possible for a display device to produce a color display if it has a laminated structure in which a plurality of display elements that exhibit a plurality of different kinds of reflected light are laminated.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A display device comprising:
a display element of matrix type;
a drive circuit that drives a pixel of the display element;
a control circuit that controls the drive circuit; and
a temperature sensor that detects the temperature of the display device, wherein:
the control circuit controls the drive circuit so that an initialization pulse to initialize a pixel to be rewritten is applied to bring about an initial gradation state and then a gradation pulse is applied to the initialized pixel to bring about a gradation state other than the initial gradation state;
the cumulative time during which the gradation pulse is applied is related to the value of the gradation state;
the control circuit:
fixes the pulse voltage of the initialization pulse and varies the pulse width of the initialization pulse in accordance with the temperature detected by the temperature sensor; and
varies the pulse width of the gradation pulse when the temperature detected by the temperature sensor is low and varies the pulse voltage of the gradation pulse when the temperature detected by the temperature sensor is high.

2. The display device according to claim 1, wherein
the control circuit increases the pulse width of the initialization pulse and the gradation pulse when the temperature detected by the temperature sensor is low and reduces the pulse voltage of the gradation pulse when the temperature detected by the temperature sensor is high.

3. The display device according to claim 1, wherein:
the gradation pulse includes a plurality of sub gradation pulses of different pulse widths; and
the control circuit varies the pulse width of the plurality of sub gradation pulses when the temperature detected by the temperature sensor is low and varies the pulse voltage of the plurality of sub gradation pulses when the temperature detected by the temperature sensor is high.

4. The display device according to claim 4, wherein
the display element includes cholesteric liquid crystal.

5. The display device according to claim 1, wherein
the initial gradation state is a planar state, a gradation state other than the initial gradation state is a state where the planar state and a focal conic state coexist in a mixed condition, the value of a gradation is determined by a coexistence ratio between the planar state and the focal conic state, and the gradation pulse increases the coexistence ratio.

6. The display device according to claim 1, wherein
the control circuit controls the wave height and the pulse width of the gradation pulse so that V²×T is substantially in proportion to η^{P} (here, 0≦p<1) where the viscosity of the display element that changes in accordance with temperature is η, the wave height of the gradation pulse is V, and the pulse width of the gradation pulse is T.

7. The display device according to claim 6, wherein
the value of p is about 0.5.

8. The display device according to claim 1, wherein
the display device comprises a laminated structure in which a plurality of the display elements that exhibit a plurality of different kinds of reflected light are laminated.

9. The display device according to claim 8, wherein
the changes of the pulse width of the initialization pulse and the pulse wave height and the pulse width of the gradation pulse in accordance with temperature are different among the plurality of display elements.

10. A driving method of a display element of dot matrix type, comprising:
a first step of applying an initialization pulse to initialize a pixel to be rewritten to bring about an initial gradation state; and
a second step of applying a gradation pulse to the pixel initialized in the first step to bring about a gradation state other than the initial gradation state, wherein:
the cumulative time during which the gradation pulse is applied in the second step is related to the value of a gradation state;
the pulse voltage of the initialization pulse is fixed and the pulse width of the initialization pulse is varied in accordance with the temperature detected by the temperature sensor;
the pulse voltage of the gradation pulse is fixed and the pulse width of the gradation pulse is varied when the temperature detected by the temperature sensor is low and the pulse voltage of the gradation pulse is varied when the temperature detected by the temperature sensor is high.

11. The driving method of a display element according to claim 10, wherein
the pulse width of the initialization pulse and the gradation pulse is increased when the temperature detected by the temperature sensor is low and the pulse voltage of the gradation pulse is reduced when the temperature detected by the temperature sensor is high.

12. The driving method of a display element according to claim 10, wherein:
the gradation pulse includes a plurality of sub gradation pulses of different pulse widths; and
the pulse width of the plurality of sub gradation pulses is varied when the temperature detected by the temperature sensor is low and the pulse voltage of the plurality of sub gradation pulses is varied when the temperature detected by the temperature sensor is high.

13. The driving method of a display element according to claim 10, wherein
the display element includes cholesteric liquid crystal.

14. The driving method of a display element according to claim 13, wherein
the initial gradation state is a planar state, a gradation state other than the initial gradation state is a state where the planar state and a focal conic state coexist in a mixed condition, the value of a gradation is determined by a coexistence ratio between the planar state and the focal conic state, and the gradation pulse increases the coexistence ratio.

15. The driving method of a display element according to claim 10, wherein
the wave height and the pulse width of the gradation pulse are varied so that V²×T is substantially in proportion to η^{P} (here, 0≦p<1) where the viscosity of the display element that changes in accordance with temperature is η, the wave height of the gradation pulse is V, and the pulse width of the gradation pulse is T/2.

16. The driving method of a display element according to claim 15, wherein
the value of p is about 0.5.

17. The driving method of a display element according to claim 10, wherein
the display device comprises a laminated structure in which a plurality of display elements that exhibit a plurality of different kinds of reflected light are laminated.

18. The driving method of a display element according to claim 17, wherein
the changes of the pulse width of the initialization pulse and the pulse wave height and the pulse width of the gradation pulse in accordance with temperature are different among the plurality of display elements.
